(19) United States
(12) Patent Application Publication
(10) Pub. No.: US 2012/0206506 A1
(43) Pub. Date: Aug. 16, 2012

(54) SYSTEMS AND METHODS FOR DRIVING A DISPLAY DEVICE

(75) Inventors: In-Suk Kim, Suwon-si (KR); Jae Goo Lee, Seongnam-si (KR); Byung Hun Han, Seoul (KR)

(73) Assignee: SAMSUNG ELECTRONICS CO., LTD., Suwon-si (KR)

(21) Appl. No.: 13/396,043

(22) Filed: Feb. 14, 2012

(30) Foreign Application Priority Data
Feb. 14, 2011 (KR) 10-2011-0012665
Mar. 14, 2011 (KR) 10-2011-0022585

(51) Int. Cl. G06F 3/038; G09G 5/10

(52) U.S. Cl. 345/690

(57) ABSTRACT

A source driver, a display device including the same, and a method of driving the display device are provided. The source driver includes a global block configured to output “k” global gamma voltage signals, where “k” is 2 or an integer greater than 2. Each “k” global gamma voltage signal comprises a plurality of grayscale voltages and a pre-emphasis voltage that is output from the global block prior to each of the plurality of grayscale voltages. A channel driver is configured to select a global gamma voltage signal of the “k” global gamma voltage signals. The selected global gamma voltage signal includes a grayscale voltage of the plurality of grayscale voltages. The channel driver outputs the grayscale voltage to a source line in response to the channel driver receiving image data.

### CROSS-REFERENCE TO RELATED APPLICATIONS

This application claims priority under 35 U.S.C. §119(a) from Korean Patent Application Nos. 10-2011-0012665 filed on Feb. 14, 2011 and 10-2011-0022585 filed on Mar. 14, 2011 the contents of each of which are hereby incorporated by reference in their entirety.

### BACKGROUND

The present inventive concepts relate to a display device, and more particularly, to a source driver, a display device including the same, and a method for driving the display device.

Liquid crystal display (LCD) devices are typically used as display devices for notebook computers and monitors. LCD devices include a panel displaying images. The panel includes a plurality of pixels. The pixels are driven according to grayscale data provided by a display driver integrated (DDI circuit) circuit of the display device so that an image can be displayed on the panel.

In general, the DDI circuit includes a grayscale voltage generation circuit which generates a plurality of grayscale voltages, e.g., 64, 128, or 256 voltages, and transmits the grayscale voltages generated by the grayscale voltage generation circuit to a channel driver. The channel driver selects and outputs one of the grayscale voltages to a data line according to digital image data. A DDI circuit generally requires many signal lines to transmit the plurality of grayscale voltages to each of channel drivers. A DDI circuit also needs a digital-to-analog converter (DAC), which occupies a significant layout area, to convert the digital image data into an analog signal. Accordingly, the DDI circuit consumes a lot of power and occupies a large layout area.

In order to overcome these problems, Korean Patent Publication No. 10-2010-0116288, the contents of which are incorporated herein in its entirety, proposes a source driver having a new structure for reducing a layout area and reducing power consumption. Here, the source driver includes a plurality of buffers, referred to as global amplifiers or gamma amplifiers, to transmit a grayscale voltage signal or related signal such as a step-wave grayscale voltage signal to a channel driver.

However, regardless of whether the plurality of global amplifiers have the same design specifications, different offsets can occur at the global amplifiers due to many variables occurring during implementation. Therefore, grayscale voltages or gamma voltages output from the global amplifiers are prone to non-monotonicity. In other words, since the global amplifiers have different offsets, the level of a gamma voltage can change depending on a global amplifier. As a result, the gamma voltage can be offset with respect to the desired level. Gaps between two gamma voltages can also occur. As a result, the global amplifiers can have problems related to non-monotonicity where gamma voltages output from the global amplifiers exhibit different characteristics with respect to one another. Moreover, necessary layout area and power consumption is increased due to the presence of the global amplifiers.

### SUMMARY

In one aspect, a source driver comprises: a global block configured to output “k” global gamma voltage signals, where “k” is 2 or an integer greater than 2, wherein each “k” global gamma voltage signal comprises a plurality of grayscale voltages and at least one pre-emphasis voltage that is output from the global block prior to each of the plurality of grayscale voltages; and a channel driver configured to select a global gamma voltage signal of the “k” global gamma voltage signals, the selected global gamma voltage signal including a grayscale voltage of the plurality of grayscale voltages, wherein the channel driver outputs the grayscale voltage to a source line in response to the channel driver receiving image data.

In some embodiments, the global block comprises “k” gamma decoders, each “k” gamma decoder receiving first through m-th grayscale voltages that sequentially increase relative to each other, each “k” gamma decoder selectively and sequentially outputting the first through m-th grayscale voltages, and each “k” gamma decoder outputting pre-emphasis voltages at a higher voltage than the second through m-th grayscale voltages for a predetermined period of time before outputting the second through m-th grayscale voltages, respectively, according to a grayscale control signal, where “m” is 2 or an integer greater than 2.

In some embodiments, the pre-emphasis voltages comprise second through m-th pre-emphasis voltages respectively corresponding to the second through m-th grayscale voltages, wherein the second through (m−1)-th pre-emphasis voltages are the same as the third through m-th grayscale voltages, respectively, and wherein the m-th pre-emphasis voltage is a dummy voltage higher than the m-th grayscale voltage.

In some embodiments, the global block comprises “k” gamma decoders, each “k” gamma decoder receiving first through m-th grayscale voltages that sequentially decrease relative to each other, each “k” gamma decoder selectively and sequentially outputting the first through m-th grayscale voltages, and each “k” gamma decoder outputting pre-emphasis voltages at a lower voltage than the second through m-th grayscale voltages for a predetermined period of time before outputting the second through m-th grayscale voltages, respectively, according to a grayscale control signal, where “m” is 2 or an integer greater than 2.

In some embodiments, the pre-emphasis voltages comprise second through m-th pre-emphasis voltages respectively corresponding to the second through m-th grayscale voltages, wherein the second through (m−1)-th pre-emphasis voltages are the same as the third through m-th grayscale voltages, respectively, and wherein the m-th pre-emphasis voltage is a dummy voltage lower than the m-th grayscale voltage.

In some embodiments, the source driver further comprises a grayscale voltage generator configured to generate (N+2)-level grayscale voltages, wherein the (N+2)-level grayscale voltages are divided into “k” groups of (m+2) levels and the “k” groups of (m+2) levels are respectively input to the gamma decoders, where N is m*k.

In some embodiments, the source driver further comprises a code generation block configured to generate a plurality of pulse width modulation (PWM) signals according to a digital code generated in response to an oscillation signal.

In some embodiments, the code generation block comprises: an oscillator configured to generate the oscillation signal; a frequency divider configured to divide a frequency of the oscillation signal by a predetermined division factor to generate a divided oscillation signal; a code generator configured to count the divided oscillation signal and generate the digital code as a count result; and a PWM signal generator configured to generate the PWM signals in response to the digital code.

In some embodiments, the source driver further comprises a grayscale controller configured to generate the grayscale control signal in response to the digital code.

In some embodiments, the grayscale control signal comprises (m+2) bits one-to-one corresponding to a first dummy voltage, first through m-th input grayscale voltages, and a second dummy voltage.

In some embodiments, the grayscale control signal comprises first through (m+2)-th bits one-to-one corresponding to a first dummy voltage, first through m-th input grayscale voltages, and a second dummy voltage, and wherein each of the “k” gamma decoders selects and outputs a voltage corresponding to an activated bit in the first through (m+2)-th bits.

In some embodiments, the channel driver comprises: a data latch configured to divide the image data into upper bits and lower bits; a switching signal generation circuit configured to generate a plurality of switching signals using a pulse width modulation (PWM) signal selected from among a plurality of PWM signals in response to the lower bits; a decoder configured to output one of the “k” global gamma voltage signals in response to the upper bits; and an output circuit configured to output the particular grayscale voltage comprised in the global gamma voltage signal output from the decoder in response to the switching signals.

In another aspect, a display device comprises: a display panel comprising a plurality of data lines, a plurality of gate lines, and a plurality of pixels, each pixel connected to one of the data lines and one of the gate lines; a gate driver configured to drive the gate lines; and a source driver configured to drive the data lines, the source driver comprising: a global block configured to output “k” global gamma voltage signals, each comprising “m” grayscale voltages and further comprising pre-emphasis voltages that correspond to the “m” grayscale voltages, where “k” and “m” are 2 or an integer greater than 2; and a channel driver configured to select a global gamma voltage signal of the “k” global gamma voltage signals, the selected global gamma voltage signal including a grayscale voltage of the plurality of grayscale voltages, wherein the channel driver outputs the grayscale voltage to a source line in response to the channel driver receiving image data.

In some embodiments, the global block comprises: a grayscale voltage generator configured to generate the plurality of grayscale voltages; a code generation block configured to generate a plurality of pulse width modulation (PWM) signals according to a digital code generated based on an oscillation signal; and a global gamma voltage signal generator configured to receive the plurality of grayscale voltages and to generate the “k” global gamma voltage signals comprising the plurality of grayscale voltages that sequentially increase or decrease relative to each other, and further comprising the pre-emphasis voltages that are output from the global block prior to the plurality of grayscale voltages in response to the digital code.

In some embodiments, the global gamma voltage signal generator comprises: a grayscale controller configured to generate a grayscale control signal in response to the digital code; and a gamma decoder configured to receive a group of first through m-th grayscale voltages among the plurality of grayscale voltages, a first dummy voltage lower than the first grayscale voltage, and a second dummy voltage higher than the m-th grayscale voltage, each gamma decoder further configured selectively and sequentially output the first through m-th grayscale voltages, and each gamma decoder configured to output pre-emphasis voltages at a higher voltage than the second through m-th grayscale voltages for a predetermined period of time before outputting the second through m-th grayscale voltages, respectively, according to the grayscale control signal.

In some embodiments, the first dummy voltage is a highest voltage in another group of grayscale voltages among the plurality of grayscale voltages or a voltage generated separately from the plurality of grayscale voltages.

In some embodiments, the second dummy voltage is a lowest voltage in another group of grayscale voltages among the plurality of grayscale voltages or a voltage generated separately from the plurality of grayscale voltages.

In some embodiments, the pre-emphasis voltages output before the second through m-th grayscale voltages are the same as the third through m-th grayscale voltages and the second dummy voltage, respectively.

In some embodiments, the global gamma voltage signal generator comprises: a grayscale controller configured to generate a grayscale control signal in response to the digital code; and a gamma decoder configured to receive a group of first through m-th grayscale voltages among the plurality of grayscale voltages, a first dummy voltage higher than the first grayscale voltage, and a second dummy voltage lower than the m-th grayscale voltage, the gamma decoder further configured to selectively and sequentially output the first through m-th grayscale voltages and further configured to output pre-emphasis voltages at a lower voltage than the second through m-th grayscale voltages for a predetermined period of time before outputting the second through m-th grayscale voltages, respectively, according to the grayscale control signal.

In some embodiments, the first dummy voltage is a lowest voltage in another group of grayscale voltages among the plurality of grayscale voltages or a voltage generated separately from the plurality of grayscale voltages.

In some embodiments, the second dummy voltage is a highest voltage in another group of grayscale voltages among the plurality of grayscale voltages or a voltage generated separately from the plurality of grayscale voltages.

In some embodiments, the pre-emphasis voltages respectively output before the second through m-th grayscale voltages are the same as the third through m-th grayscale voltages and the second dummy voltage, respectively.

In some embodiments, the grayscale control signal comprises (m+2) bits one-to-one corresponding to the first dummy voltage, the first through m-th grayscale voltages, and the second dummy voltage.

In some embodiments, a global gamma voltage signal output from the gamma decoder is input to the channel driver without transmission through an amplifier or a buffer.

In another aspect, a method of driving a plurality of data lines in a display device, the method comprises: generating a plurality of grayscale voltages and at least one dummy voltage; generating a plurality of global gamma voltage signals, each comprising a predetermined number of grayscale voltages which sequentially increase or decrease and a plurality of pre-emphasis voltages output prior to the predetermined number of grayscale voltages; selecting a global gamma voltage signal of the plurality of global gamma voltage signals; and outputting a grayscale voltage of the predetermined number of grayscale voltages to a data line in response to a receipt of image data.

In some embodiments, selecting the global gamma voltage signal and outputting the grayscale voltage comprises: selecting one of the global gamma voltage signals according to upper bits in the image data; and sampling the grayscale voltage in the selected global gamma voltage signal according to lower bits in the image data and outputting the particular grayscale voltage to the one of the data lines.

In another aspect, a source driver comprises: a grayscale voltage generator configured to generate N-level grayscale voltages, where N is 2 or an integer greater than 2; a code generation block configured to generate a digital code comprising “h” bits based on an oscillation signal, where “h” is 2 or an integer greater than 2 “k” gamma decoders, each receiving “r” voltages comprising “m” grayscale voltages of the N-level grayscale voltages and at least one dummy voltage, each “k” gamma decoder generating a global gamma voltage signal by selectively outputting the “r” voltages in response to a grayscale control signal, where “m” is 2^{h} and “r” is an integer greater than “m”; a grayscale controller configured to generate the grayscale control signal in response to the digital code; and a channel driver configured to select a global gamma voltage signal of the global gamma voltage signals output from the “k” gamma decoders, and further configured to output a grayscale voltage of the selected global gamma voltage signal to a source line decoder in response to a receipt of image data.

In some embodiments, the grayscale control signal comprises “r” bits one-to-one corresponding to the “r” voltages.

In some embodiments, each of the “k” gamma decoders comprises “r” switches each of which outputs one of the “r” voltages in response to one of the “r” bits of the grayscale control signal.

In some embodiments, the N-level grayscale voltages are divided into “k” groups of m-level grayscale voltages, wherein the “k” groups of m-level grayscale voltages are respectively input to the “k” gamma decoders, and wherein the at least one dummy voltage is a grayscale voltage belonging to any of the “k” groups other than a group input to a gamma decoder receiving the at least one dummy voltage among the “k” gamma decoders or is a voltage generated separately from the grayscale voltages.

In some embodiments, each of the gamma decoders outputs pre-emphasis voltages corresponding to the m-level grayscale voltages, respectively, before outputting the m-level grayscale voltages.

In some embodiments, a pre-emphasis voltage corresponding to each of the grayscale voltages is one level higher or lower than each grayscale voltage.

In another aspect, a source driver comprises: a global block configured to output “k” global gamma voltage signals, each comprising a plurality of grayscale voltages, where “k” is 2 or an integer greater than 2; and a channel driver configured to select a global gamma voltage signal of the “k” global gamma voltage signals and further configured to output a grayscale voltage comprised in the selected global gamma voltage signal to a source line according to image data, wherein the global block comprises a grayscale voltage generator configured to generate N-level grayscale voltages using a resistor string having an effective resistance of at least one resistance element connected between a first transition node and a second transition node changes, where N is 2 or an integer greater than 2.

In some embodiments, the first transition node is a node outputting a lowest grayscale voltage or a highest grayscale voltage of a global gamma voltage signal of the “k” global gamma voltage signals, and the second transition node is a node outputting a lowest or highest one of the grayscale voltages comprised in another global gamma signal of the “k” global gamma voltage signals.

In some embodiments, the resistor string comprises a plurality of resistance elements connected in series between a first reference node receiving a first reference voltage and a second reference node receiving a second reference voltage, and wherein the plurality of resistance elements includes the at least one resistance element.

In some embodiments, the at least one resistance element comprises: at least one unit resistor connected between a first node and a second node in the resistance string; and a fuse connected in parallel with the at least one unit resistor.

In some embodiments, the fuse is initially in a connected state and is selectively cut.

In some embodiments, the fuse is initially in a disconnected state and is selectively connected.

In some embodiments, the at least one resistance element comprises a unit resistor and a fuse connected in series between a first node and a second node in the resistance string.

In some embodiments, the at least one resistance element comprises: at least one unit resistor connected between a first node and a second node in the resistance string; and a switch connected in parallel or in series with the at least one unit resistor.

In some embodiments, the channel driver comprises: a data latch configured to latch the image data and divide the image data into upper bits and lower bits; a switching signal generation circuit configured to generate a plurality of switching signals using a pulse width modulation (PWM) signal selected from a plurality of PWM signals in response to the lower bits; a decoder configured to output a global gamma voltage signal selected from the “k” global gamma voltage signals in response to the upper bits; and an output circuit configured to output the particular grayscale voltage comprised in the global gamma voltage signal output from the decoder in response to the switching signals.

In some embodiments, the global block comprises: a code generation block configured to generate a plurality of pulse width modulation (PWM) signals according to a digital code generated based on an oscillation signal; a plurality of gamma decoders each of which receives a group of a predetermined number of grayscale voltages among the N-level grayscale voltages and generates one of the “k” global gamma voltage signals by sequentially outputting the predetermined number of grayscale voltages in the group according to the digital code; and a plurality of gamma amplifiers configured to amplify and output the “k” global gamma voltage signals, respectively.

In some embodiments, the source driver further comprises a control block configured to generate a resistance control signal to control the effective resistance of the at least one resistance element.

In some embodiments, the control block comprises: a measurer configured to measure a voltage difference between output signals of two adjacent gamma amplifiers among the plurality of gamma amplifiers; and a resistance control signal generator configured to generate the resistance control signal according to the voltage difference measured by the measurer.

In some embodiments, the control block comprises a memory configured to store the resistance control signal.

In some embodiments, the at least one resistance element is connected between a first node configured to output a lowest grayscale voltage of a global gamma voltage signal of the “k” global gamma voltage signals and a second node configured to output a highest grayscale voltages of another global gamma voltage signal of the “k” global gamma voltage signals.

In some embodiments, a voltage difference between two adjacent grayscale voltages belonging to different global gamma voltage signals among the “k” global gamma voltage signals changes according to the effective resistance of the at least one resistance element.

In some embodiments, the global block further comprises: a first gamma decoder configured to receive a first group of a predetermined number of grayscale voltages of the N-level grayscale voltages and generate a first global gamma voltage signal according to the digital code; a second gamma decoder configured to receive a second group of a predetermined number of grayscale voltages of the N-level grayscale voltages and generate a second global gamma voltage signal according to the digital code; a first gamma amplifier configured to buffer and transmit the first global gamma voltage signal to the channel driver; and a second gamma amplifier configured to buffer and transmit the second global gamma voltage signal to the channel driver, wherein the effective resistance of the at least one resistance element is changed to control a gap between the first group of grayscale voltages and the second group of grayscale voltages.

In some embodiments, a display device comprises: a display panel comprising a plurality of data lines, a plurality of gate lines, and a plurality of pixels, each pixel connected with one of the data lines and one of the gate lines; a gate driver configured to gate the gate lines; and a source driver configured to drive the data lines, the source driver comprising a global block configured to output “k” global gamma voltage signals, each “ global gamma voltage signal comprising “m” grayscale voltages and pre-emphasis voltages, respectively, that correspond to the “m” grayscale voltages, where “k” and “m” are 2 or an integer greater than 2; and a channel driver configured to select a global gamma voltage signal of the “k” global gamma voltage signals and output a grayscale voltage comprised in the selected global gamma voltage signal to a source line according to image data, wherein the global block comprises a grayscale voltage generator configured to generate N-level grayscale voltages using a resistor string in which an effective resistance of at least one resistance element connected between a first transition node and a second transition node changes, where N is 2 or an integer greater than 2.

In some embodiments, the first transition node is a node outputting a lowest or highest one of the grayscale voltages comprised in one of the “k” global gamma voltage signals, and wherein the second transition node is a node outputting a lowest or highest one of the grayscale voltages comprised in another one of the “k” global gamma voltage signals.

In some embodiments, the at least one resistance element comprises: at least one unit resistor connected between a first node and a second node in the resistance string; and a fuse connected in parallel with the at least one unit resistor.

In some embodiments, the at least one resistance element comprises a unit resistor and a fuse connected in series between a first node and a second node in the resistance string.

In another aspect, a method of driving a plurality of data lines in a display device comprises: variably setting an effective resistance of at least one resistance element connected between a first transition node and a second transition node in a resistor string, the resistor string comprising a plurality of resistance elements connected between a first reference node and a second reference node; generating a plurality of grayscale voltages using the resistor string; generating a plurality of global gamma voltage signals having a step waveform by dividing the plurality of grayscale voltages into at least two groups and sequentially outputting grayscale voltages in each of the groups; and selecting a global gamma voltage signal from the plurality of global gamma voltage signals and outputting a particular grayscale voltage comprised in the selected global gamma voltage signal to one of the data lines in response to image data.

In some embodiments, the operation of variably setting an effective resistance of at least one resistance element comprises changing a state of a fuse connected in series or parallel with at least one unit resistor included in the at least one resistance element.

In some embodiments, the operation of variably setting an effective resistance of at least one resistance element comprises changing a state of a switch connected in series or parallel with at least one unit resistor included in the at least one resistance element.

In another aspect, a source driver comprises: a global block that generates a global gamma voltage signal, the global gamma voltage signal comprising a plurality of grayscale voltages and a pre-emphasis voltage, wherein the pre-emphasis voltage is output at a predetermined period of time prior to the plurality of grayscale voltages; and a channel driver that receives image display data, receives the global gamma voltage signal from the global block, selects a grayscale voltage of the plurality of grayscale voltage in response to the image display data, and outputs the selected grayscale voltage to a source line.

In some embodiments, the global block comprises: a grayscale voltage generator that generates the plurality of grayscale voltages; and a global gamma voltage signal generator including a plurality of “k” gamma decoders, where “k” is 2 or an integer greater than 2, a gamma decoder of the “k” gamma decoders outputting the pre-emphasis voltage at the predetermined period of time prior to the grayscale voltages.

In some embodiments, a gamma decoder of the “k” gamma decoders outputs first through m-th grayscale voltages of the plurality of grayscale voltages that sequentially increase relative to each other, and outputs the pre-emphasis voltage corresponding to the plurality of grayscale voltages at a higher voltage than the second through m-th grayscale voltages, in response to a grayscale control signal, where “m” is 2 or an integer greater than 2.

In some embodiments, a gamma decoder of the “k” gamma decoders outputs first through m-th grayscale voltages of the plurality of grayscale voltages that sequentially decrease relative to each other, and outputs the pre-emphasis voltage corresponding to the plurality of grayscale voltages at a lower voltage than the second through m-th grayscale voltages, in response to a grayscale control signal, where “m” is 2 or an integer greater than 2.

### BRIEF DESCRIPTION OF THE DRAWINGS

The above and other features and advantages of the present inventive concepts will become more apparent by describing in detail exemplary embodiments thereof with reference to the attached drawings in which:

FIG. 1A is a block diagram of a display device according to some embodiments of the present inventive concepts;

FIG. 1B is a circuit diagram of a pixel circuit when a display panel illustrated in FIG. 1A is a thin film transistor liquid crystal display (TFT-LCD) panel;

FIG. 1C is a circuit diagram of a pixel circuit when the display panel illustrated in FIG. 1A is an organic light emitting diode (OLED) panel;

FIG. 2 is a schematic block diagram of a source driver illustrated in FIG. 1 according to some embodiments of the present inventive concepts;

FIG. 3 is a detailed block diagram of the source driver illustrated in FIG. 2;

FIG. 4 is a diagram showing a global block illustrated in FIG. 3 according to some embodiments of the present inventive concepts;

FIG. 5 is a schematic block diagram of a channel driver illustrated in FIG. 2 according to some embodiments of the present inventive concepts;

FIG. 6 is a circuit diagram of a gamma decoder illustrated in FIG. 4 according to some embodiments of the present inventive concepts;

FIG. 7 is a diagram of the ideal waveform of a global gamma voltage signal according to some embodiments of the present inventive concepts;

FIG. 8 is a diagram of the ideal waveforms of a grayscale control signal for outputting the global gamma voltage signal illustrated in FIG. 7;

FIG. 9 is a diagram of the ideal waveform of a global gamma voltage signal according to other embodiments of the present inventive concepts;

FIG. 10 is a diagram of the ideal waveforms of a grayscale control signal for outputting the global gamma voltage signal illustrated in FIG. 9;

FIGS. 11 and 12 are diagrams of the ideal waveforms of a global gamma voltage signal in comparative examples;

FIG. 13 is a flowchart of a method of driving a display device according to some embodiments of the present inventive concepts;

FIG. 14 is a diagram of the global block illustrated in FIG. 3 according to other embodiments of the present inventive concepts;

FIG. 15 is a schematic block diagram of the channel driver illustrated in FIG. 2 according to other embodiments of the present inventive concepts;

FIG. 16 is a detailed diagram of a resistor string illustrated in FIG. 14;

FIG. 17 is a circuit diagram of a resistance element illustrated in FIG. 16;

FIG. 18 is a table showing effective resistance according to whether a first fuse and a second fuse are cut in the resistance element illustrated in FIG. 17;

FIG. 19A is a diagram showing the connection when any of the first and second fuses are not cut in the resistance element illustrated in FIG. 17;

FIG. 19B is a diagram showing the connection when only the first fuse is cut in the resistance element illustrated in FIG. 17;

FIG. 19C is a diagram showing the connection when all of the first and second fuses are cut in the resistance element illustrated in FIG. 17;

FIGS. 20A through 20C are diagrams of global gamma voltage signals having first, second and third voltage gaps according to the cut-off of the first and second fuses;

FIGS. 21 and 22 are circuit diagrams of a resistance element according to different embodiments of the present inventive concepts;

FIG. 23 is a diagram showing the global block illustrated in FIG. 3 according to further embodiments of the present inventive concepts;

FIG. 24 is a diagram of the detailed structure of a resistance string and a control block illustrated in FIG. 23;

FIG. 25 is a circuit diagram of a resistance element illustrated in FIG. 24 according to some embodiments of the present inventive concepts;

FIG. 26 is a table showing effective resistance according to whether first through third switches are turned on or off in the resistance element illustrated in FIG. 25;

FIGS. 27A through 27D are diagrams of global gamma voltage signals having fourth, fifth, sixth and seventh voltage gaps according to the on/off of the first through third switches illustrated in FIG. 25;

FIGS. 28 and 29 are flowcharts of a method of driving a display device according to other embodiments of the present inventive concepts;

FIG. 30 is a block diagram of an electronic system including a display device according to some embodiments of the present inventive concepts; and

FIG. 31 is a block diagram of an electronic system including a display device according to other embodiments of the present inventive concepts.

### DETAILED DESCRIPTION OF THE EMBODIMENTS

The present inventive concepts now will be described more fully hereinafter with reference to the accompanying drawings, in which embodiments of the inventive concepts are shown. This inventive concepts may, however, be embodied in many different forms and should not be construed as limited to the embodiments set forth herein. Rather, these embodiments are provided so that this disclosure will be thorough and complete, and will fully convey the scope of the inventive concepts to those skilled in the art. In the drawings, the size and relative sizes of layers and regions may be exaggerated for clarity. Like numbers refer to like elements throughout.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the inventive concepts. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which the inventive concepts belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

In brief overview, embodiments of the systems and methods described herein include source driver configurations which generate global gamma voltage signal which are required to be transmitted through a global amplifier, buffer, and the like, when directed to a channel driver. In this manner, problems related to non-monotonicity due to offsets between global amplifiers are reduced or eliminated. To achieve this, embodiments include decoder configuration changes, for example, 18(m+2):1 decoders, where m is an integer greater than 1. Other embodiments include decoders having a pre-emphasis voltage generator, described herein. In other embodiments, source driver configurations include global amplifiers. Here, resistor strings include fuses or related elements that can variably change an effective resistance of the resistor string. In this manner, differences between output signals of the global amplifiers can be controller, thereby addressing non-monotonicity and related problems.

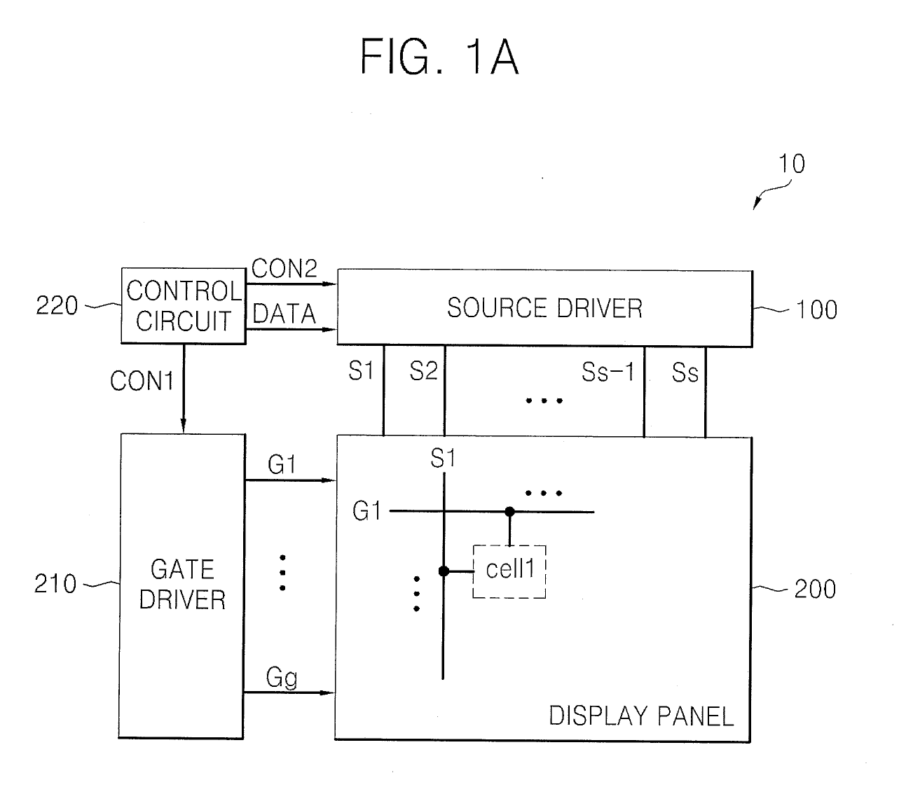

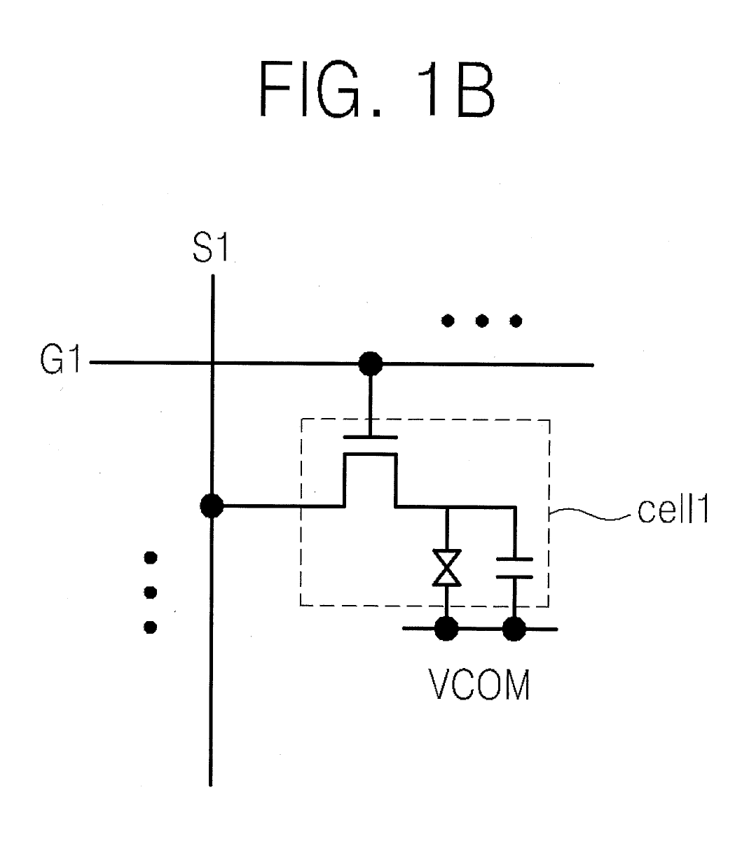

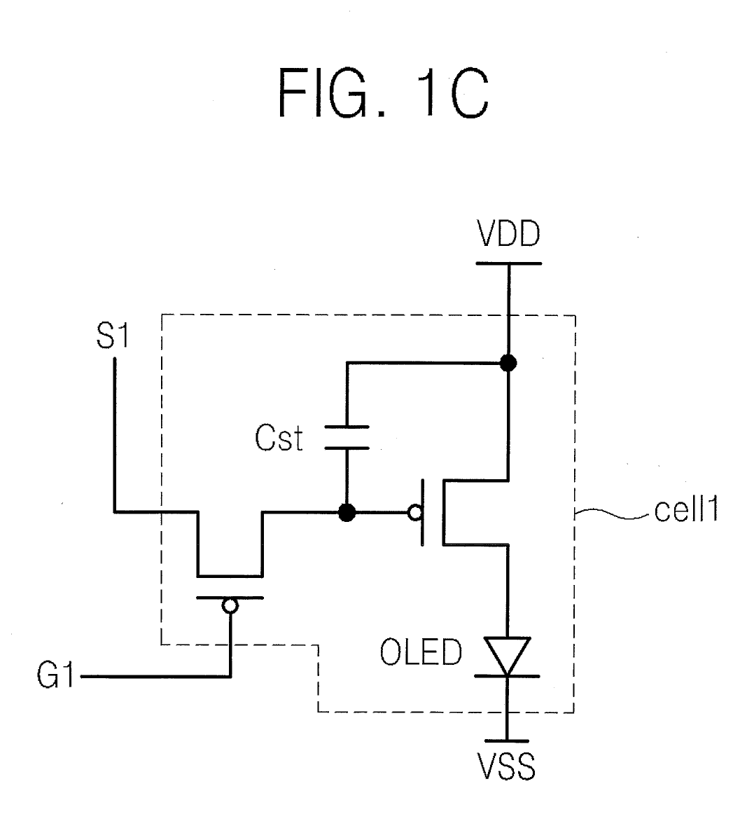

FIG. 1A is a block diagram of a display device 10 according to some embodiments of the present inventive concepts. FIG. 1B is a circuit diagram of a pixel circuit when a display panel 200 illustrated in FIG. 1A is a thin film transistor liquid crystal display (TFT-LCD) panel. FIG. 1C is a circuit diagram of a pixel circuit when the display panel 200 illustrated in FIG. 1A is an organic light emitting diode (OLED) panel.

Referring to FIG. 1A, the display device 10 includes the display panel 200, a control circuit 220, a gate driver 210, and a source driver 100.

The display panel 200 includes a plurality of source lines S1 through Ss where “s” is a natural number, a plurality of gate lines G1 through Gg where “g” is a natural number and g=s or g≠s, and a plurality of pixel circuits, each including a unit pixel cell 1. Each of the pixel circuits is connected between one of the source lines S1 through Ss and one of the gate lines G1 through Gg.

The display panel 200 can be a flat display panel such as a TFT-LCD panel, a plasma display panel (PDP), a light emitting diode (LED) panel, or an OLED panel. The present inventive concepts are not restricted to the examples herein.

The unit pixel cell 1 has the structure illustrated in FIG. 1B when the display panel 200 is a TFT-LCD panel and the structure illustrated in FIG. 1C when the display panel 200 is an OLED panel, but the present inventive concepts are not restricted to the current embodiments.

The control circuit 220 generates a plurality of control signals including a first control signal CON1 and a second control signal CON2. The first control signal CON1 is output to the gate driver 210. The second control signal CON2 is output to the source driver 100. The control circuit 220 can generate the first control signal CON1, the second control signal CON2, and image data DATA based on a horizontal synchronization signal and a vertical synchronization signal.

The gate driver 210 drives the gate lines G1 through Gg sequentially in response to the first control signal CON1. The first control signal CON1 can be an indicator instructing to start the scanning of the gate lines G1 through Gg.

The source driver 100 drives the source lines S1 through Ss in response to the second control signal CON2 and the digital image data DATA, which are output from the control circuit 220. The source lines S1 through Ss are also referred to as data lines. A driver for driving a single data line is referred to as a channel driver.

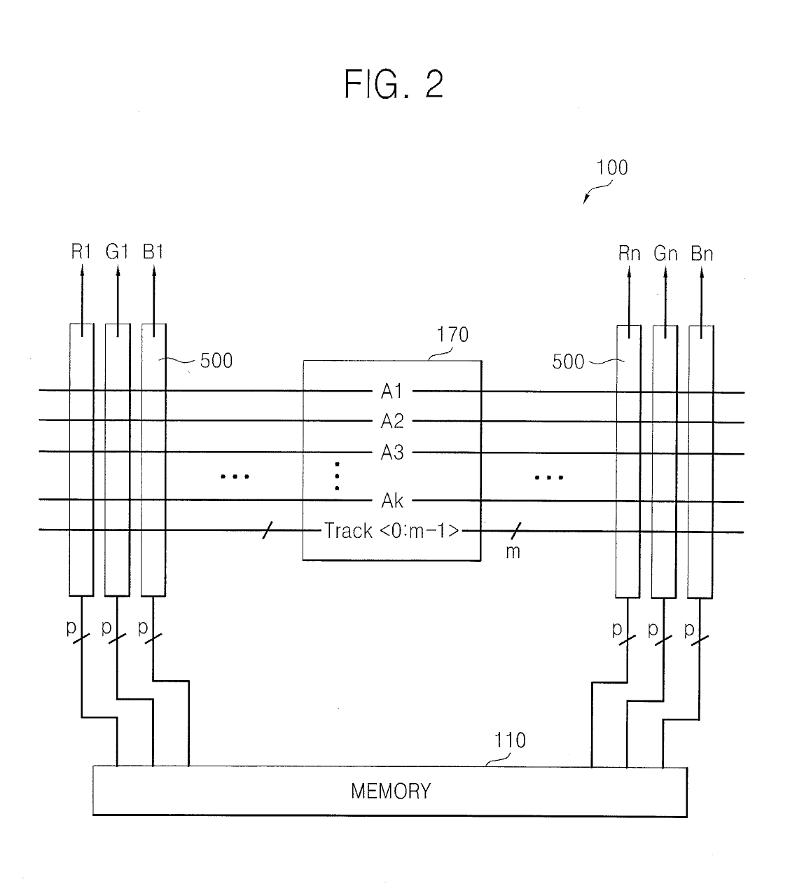

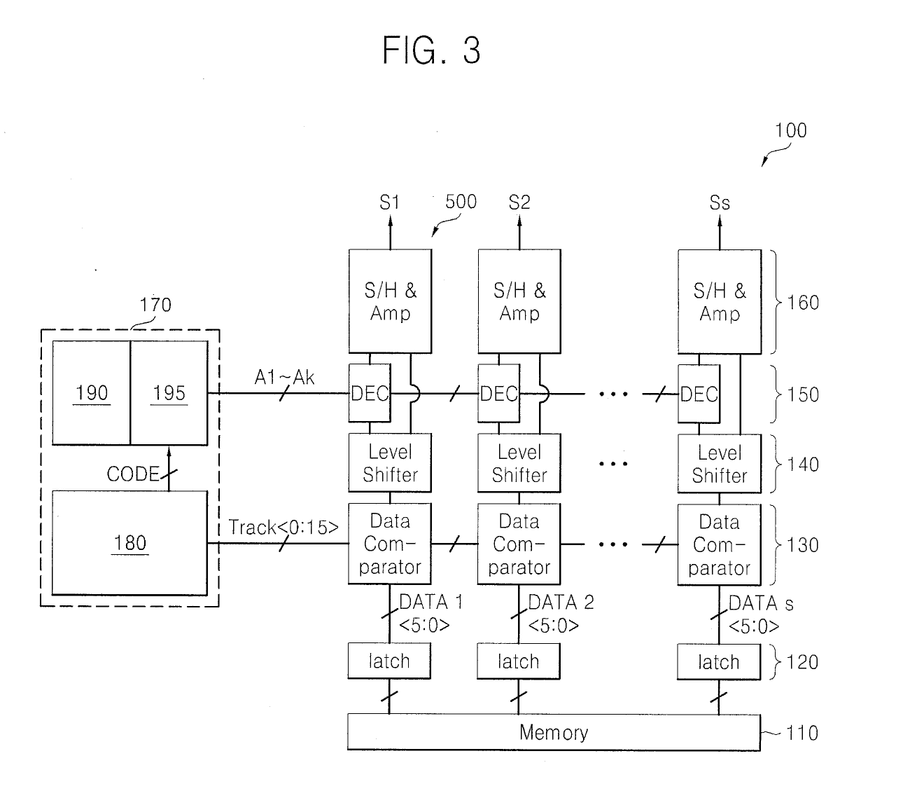

FIG. 2 is a schematic block diagram of the source driver 100 illustrated in FIG. 1 according to some embodiments of the present inventive concepts. FIG. 3 is a detailed block diagram of the source driver 100 illustrated in FIG. 2.

Referring to FIGS. 2 and 3, the source driver 100, also referred to as a data line driver, includes a global block 170 and a channel driving part. The channel driving part includes a plurality of channel drivers 500.

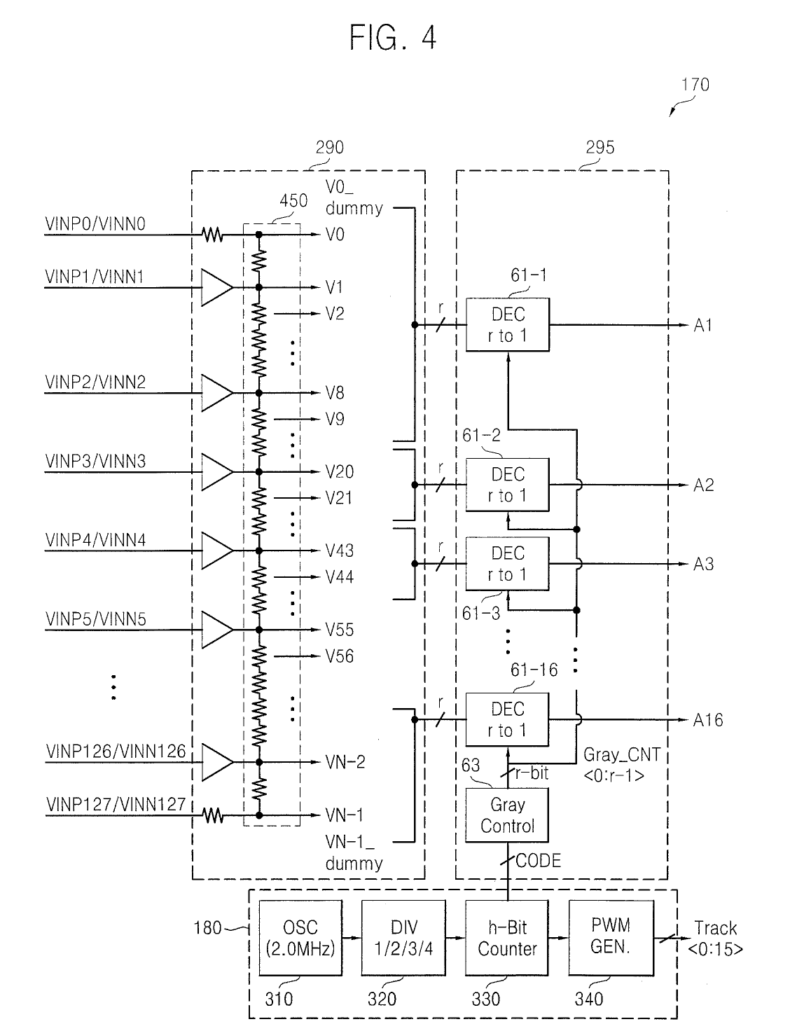

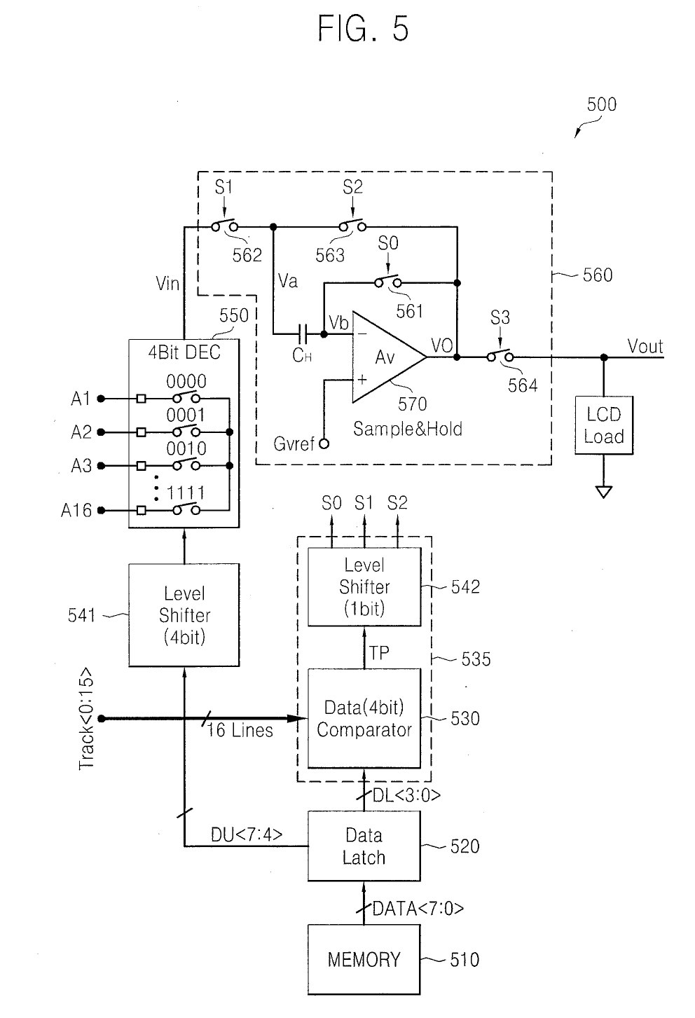

The global block 170 generates a plurality of pulse width modulation (PWM) signals Track<0:m−1> (where “m” is 2 or an integer greater than 2) and “k (2 or an integer greater than 2)” global gamma voltage signals A1 through Ak according to a digital code CODE generated based on an oscillation signal. Each of the channel drivers 500 drives one of the source lines, i.e., data lines, S1 through Ss included in the display panel 200 in response to the PWM signals Track<0:m−1>, the “k” global gamma voltage signals A1 through Ak, and the digital image data DATA, so that the pixel circuits in the display panel 200 display the image data DATA. The structures and the operations of the global block 170 and the channel drivers 500 will be described in detail herein with reference to FIGS. 4 and 5.

The global block 170 is common to all channels and can include a code generation block 180, a grayscale voltage generator 190, and a global gamma voltage signal generator 195.

The channel driving part is a circuit for driving the channels and can include a memory 110, a latch block 120, a data comparison block 130, a level shifter block 140, a decoding block 150, and an output circuit 160.

A circuit which drives a single data line in the channel driving part is referred to as a channel driver 500, illustrated at FIG. 5. Accordingly, the channel driving part can include a plurality of channel drivers 500, for example, as many as the number of channels.

An output of the global block 170 is connected to the inputs of each common channel driver 500.

When the display panel 200 includes red (R), green (G) and blue (B) pixels, the number of channel drivers 500 can be 3*n, where “n” is a natural number. For instance, when the source driver 100 drives a quarter video graphic array (QVGA), “n” is 240 and the number of data lines, i.e. “s” is 3*n=720. In other words, the number of channels is 720. In this case, the output of the global block 170 is connected to the inputs of the respective 720 common channel drivers 500.

FIG. 4 is a diagram showing the global block 170 illustrated in FIG. 3 according to some embodiments of the present inventive concepts.

Referring to FIG. 4, the global block 170 includes the code generation block 180, a grayscale voltage generator 290, and a global gamma voltage signal generator 295. The code generation block 180 includes an oscillator 310, a frequency divider 320, a code generator 330, and a PWM signal generator 340. The oscillator 310 generates an oscillation signal having a predetermined frequency. The predetermined frequency can be 1.5 through 2.5 MHz, but the present inventive concepts are not restricted to this example.

The frequency divider 320 divides the frequency of the oscillation signal generated by the oscillator 310 by a predetermined division factor (e.g., 1, 2, 3 or 4) to generate a divided oscillation signal. For instance, the period of the oscillation signal can be 0.5 μs. Here, when the division factor is 1, the period of the divided oscillation signal is also 0.5 μs. When the division factor is 2, the period of the divided oscillation signal is 1 μs, i.e., the double of the period of the oscillation signal. When the division factor is 3, the period of the divided oscillation signal is 1.5 μs, i.e., the triple of the period of the oscillation signal. The division factor can be a real number and can be controlled by a register (not shown).

The code generator 330 counts the divided oscillation signal generated by the frequency divider 320 and generates a digital code CODE as a count result. The code generator 330 can be implemented by a counter. For instance, the code generator 330 can count rising or falling edges of the divided oscillation signal and generate an h-bit digital code CODE corresponding to a count result.

Here, “h” is a natural number. In some embodiments of the present inventive concepts, the code generator 330 is a 4-bit counter. In this case, the counter outputs a 4-bit digital code CODE which increases by one from 0 (e.g., 0000) to 15 (e.g., 1111) at each period of the divided oscillation signal.

The PWM signal generator 340 receives the 4-bit digital code CODE from the code generator 330 and performs PWM on the 4-bit digital code CODE to generate a plurality of PWM signals Track<0:15>. For instance, when the 4-bit digital code CODE increases from 0000 to 1111 sequentially, the PWM signal generator 340 generates the PWM signals Track<0:15> whose pulse width increases in a period of one least significant bit (LSB).

The grayscale voltage generator 290 receives at least two reference voltages VINP9 through VINP127 or VINN0 through VINN127 and generates a plurality of, e.g., N grayscale voltages V0 through VN−1 where N is a natural number. The grayscale voltage generator 290 can include a resistor string 450.

The grayscale voltage generator 290 can also generate one or more dummy voltages V0_dummy and VN−1_dummy. The dummy voltages V0_dummy and VN−1_dummy can be provided from the outside of the source driver 100 or can be generated in the grayscale voltage generator 290. For instance, the grayscale voltage generator 290 can generate the dummy voltages V0_dummy and VN−1_dummy using the resistor string 450 or a charge pump (not shown), but the present inventive concepts are not restricted to this example.

In the current embodiments, the grayscale voltage generator 290 receives the reference voltages VINP0 through VINP127 or VINN0 through VINN127 respectively at 128 levels and generates N (e.g., 64, 128 or 256) grayscale voltages V0 through VN−1 and the first and second dummy voltages V0_dummy and VN−1_dummy. It is assumed that N is 256 and 256-level grayscale voltages V0 through V255 sequentially decrease from the grayscale voltage V0 to the grayscale voltage V255. However, the present inventive concepts are not restricted to the current embodiments. Also, the gap between adjacent grayscale voltages does not need to be constant. The first dummy voltage V0_dummy can be higher than the highest grayscale voltage V0 and the second dummy voltage V255_dummy can be lower than the lowest grayscale voltage V255.

In other embodiments of the present inventive concepts, the 256-level grayscale voltages V0 through V255 can sequentially increase from the grayscale voltage V0 to the grayscale voltage V255.

The resistor string 450 includes a plurality of resistance elements connected in series between a node receiving one reference voltage and a node receiving another reference voltage and divides a range between the two reference voltages, thereby generating a plurality of (e.g., 256) grayscale voltages (e.g., V0 through V255). The 256 grayscale voltages are referred to as 256 gray direct current (DC) voltages.

The global gamma voltage signal generator 295 receives the grayscale voltages V0 through V255 and generates the “k” global gamma voltage signals A1 through Ak. Here, “k” is 2 or a natural number greater than 2. In the current embodiments, “k” is 16; however, the present inventive concepts are not restricted to the current embodiments.

Each of the global gamma voltage signals A1 through Ak can include a plurality of “m” grayscale voltages where “m” is a natural number. Here, “m” can be the number of grayscale voltages (e.g., 256) divided by “k”. Each of the “k” global gamma voltage signals A1 through Ak includes m-level grayscale voltages which sequentially increase or decrease. Each of the “k” global gamma voltage signals A1 through Ak includes a pre-emphasis voltage corresponding to each of the grayscale voltage before each grayscale voltage.

The global gamma voltage signal generator 295 includes “k” gamma decoders 61-1 through 61-16. In the current embodiments, each of the “k (e.g., 16)” gamma decoders 61-1 through 61-16 can be implemented by an r-to-1 decoder that receives “r (e.g., 18 where “r” is a natural number greater than “m”)” input signals (i.e., “m” grayscale voltages and at least one dummy voltage) and outputs a single global gamma voltage signal, but the present inventive concepts are not restricted to the current embodiments. Here, “m” is 2^{h} and “m” is 16 when “h” is 4, but the present inventive concepts are not restricted thereto.

In addition, “r” is the number of voltages input to a single gamma decoder, and “r” can be m+1 or m+2 because there is at least one dummy voltage in the current embodiments. For example, the decoder can be an 18(m+2):1 decoder. The present inventive concepts are not restricted to the current embodiments.

Each of the gamma decoders 61-1 through 61-16 receives m-level grayscale voltages (referred to as first through m-th grayscale voltages for clarity of the description) among the entire grayscale voltages V0 through V255 and sequentially selects and outputs the first through m-th grayscale voltages in response to a grayscale control signal Gray_CNT<0:r−1>. At this time, each of the gamma decoders 61-1 through 61-16 outputs a pre-emphasis voltage higher or lower than a grayscale voltage to be output among the first through m-th grayscale voltages for a predetermined period of time.

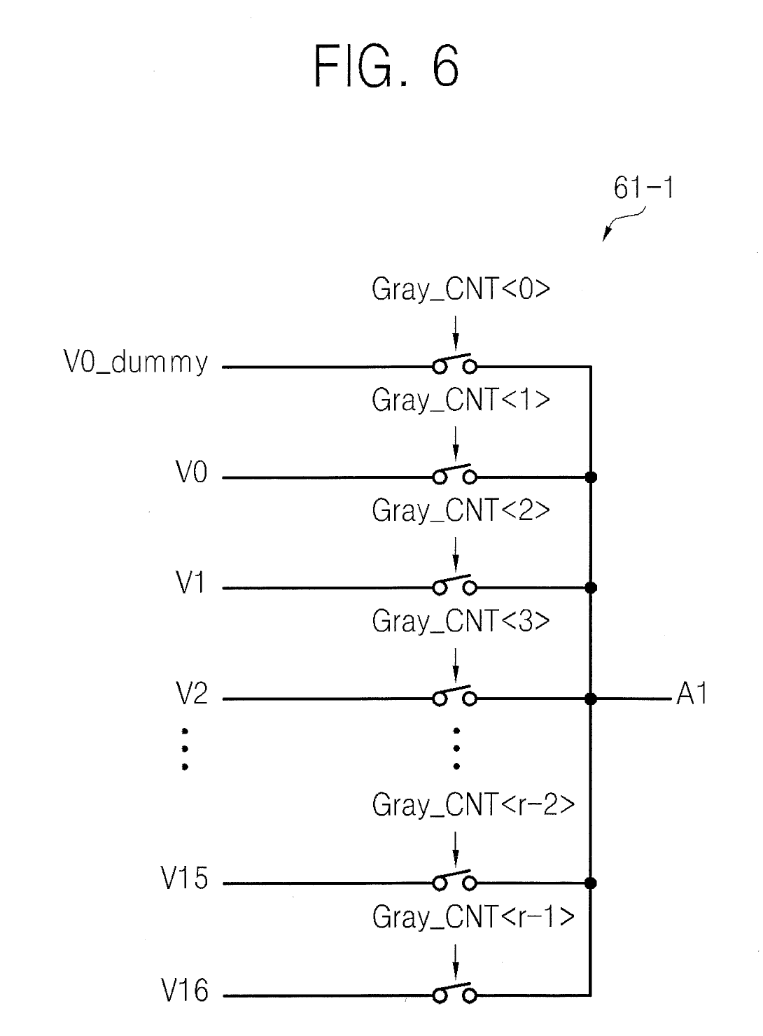

FIG. 6 is a circuit diagram of the gamma decoder 61-1 illustrated in FIG. 4 according to some embodiments of the present inventive concepts. Referring to FIG. 6, the gamma decoder 61-1 can include “r” switches turned on or off in response to “r” bits, respectively, in the grayscale control signal Gray_CNT<0:r−1>. The other gamma decoders 61-2 through 61-16 can be implemented in the same manner as the gamma decoder 61-1. Therefore, descriptions thereof will be omitted.

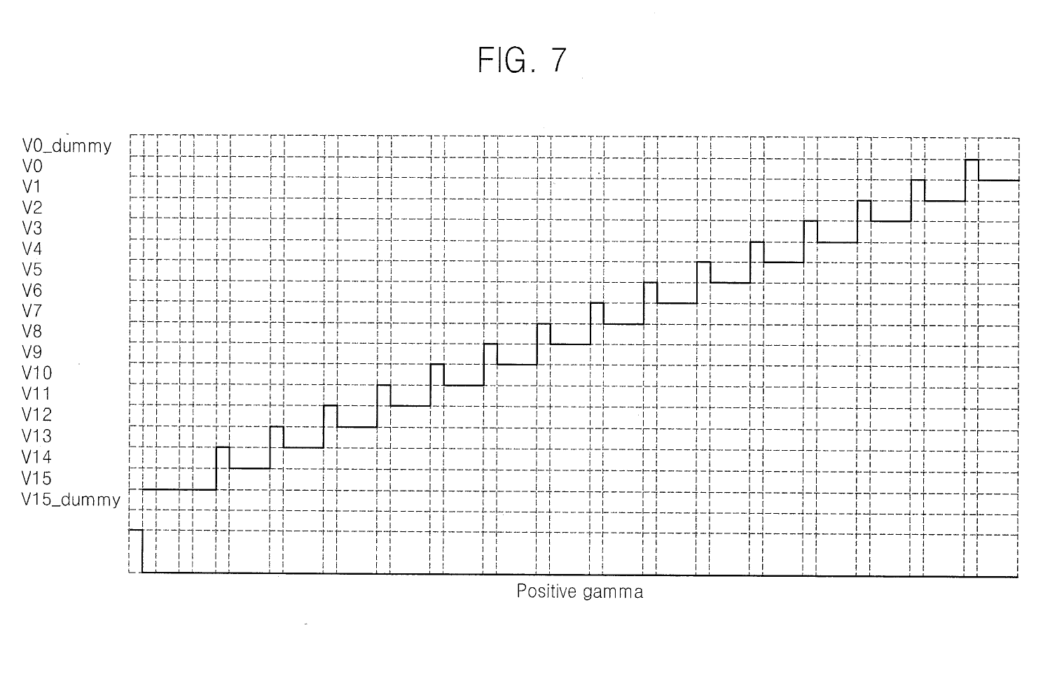

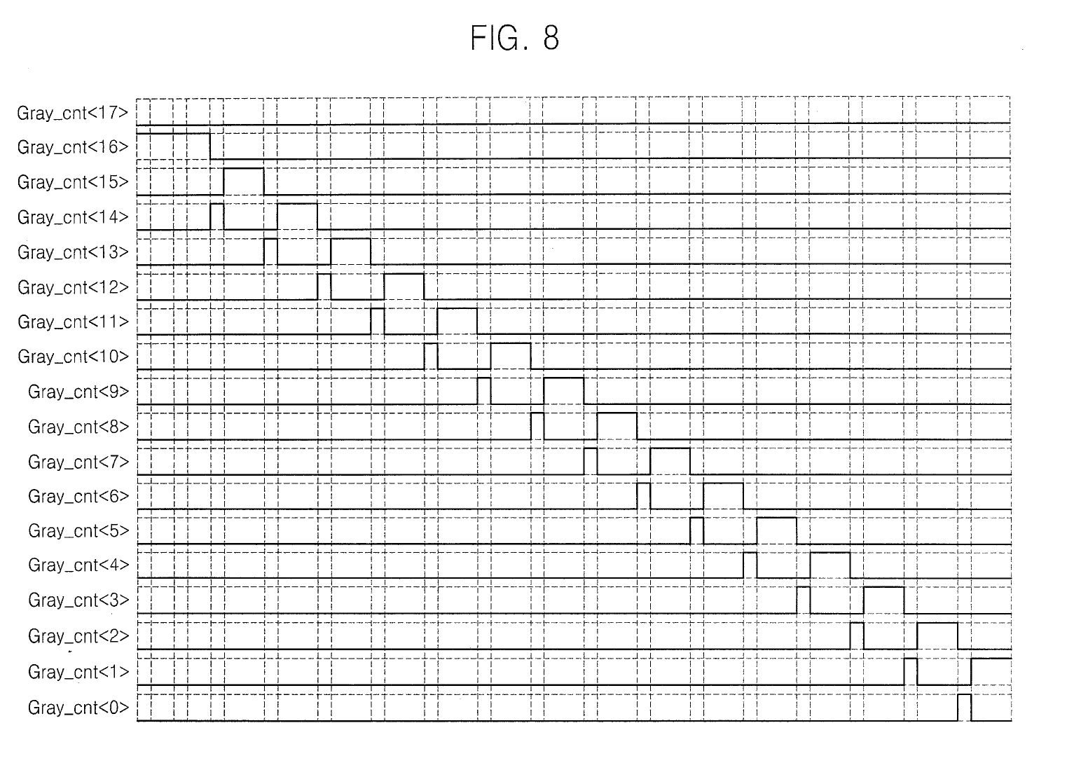

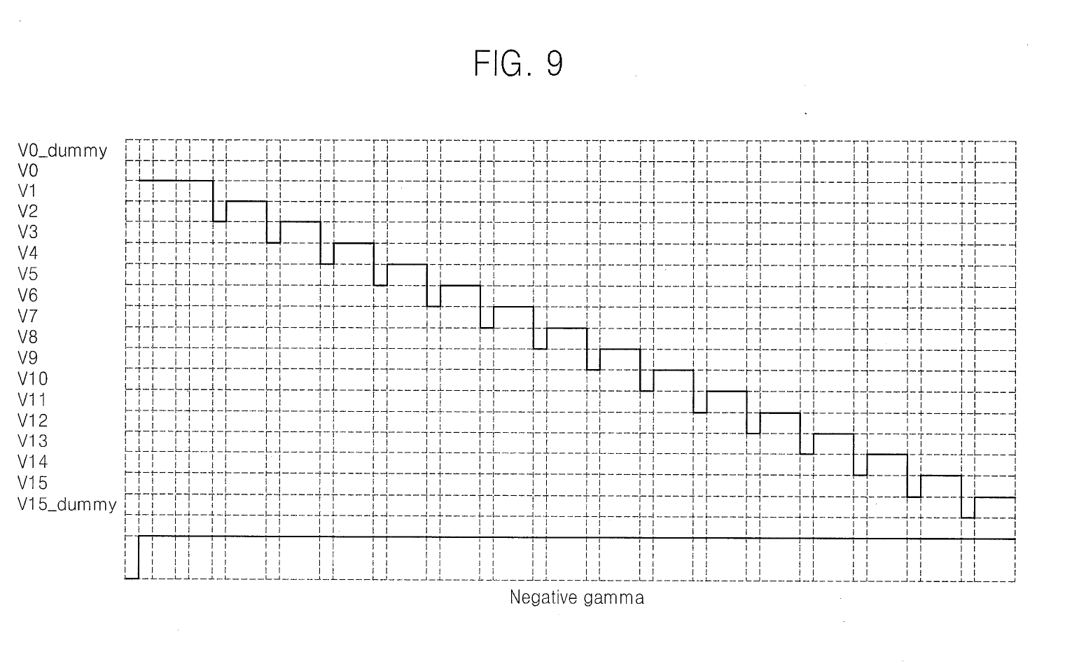

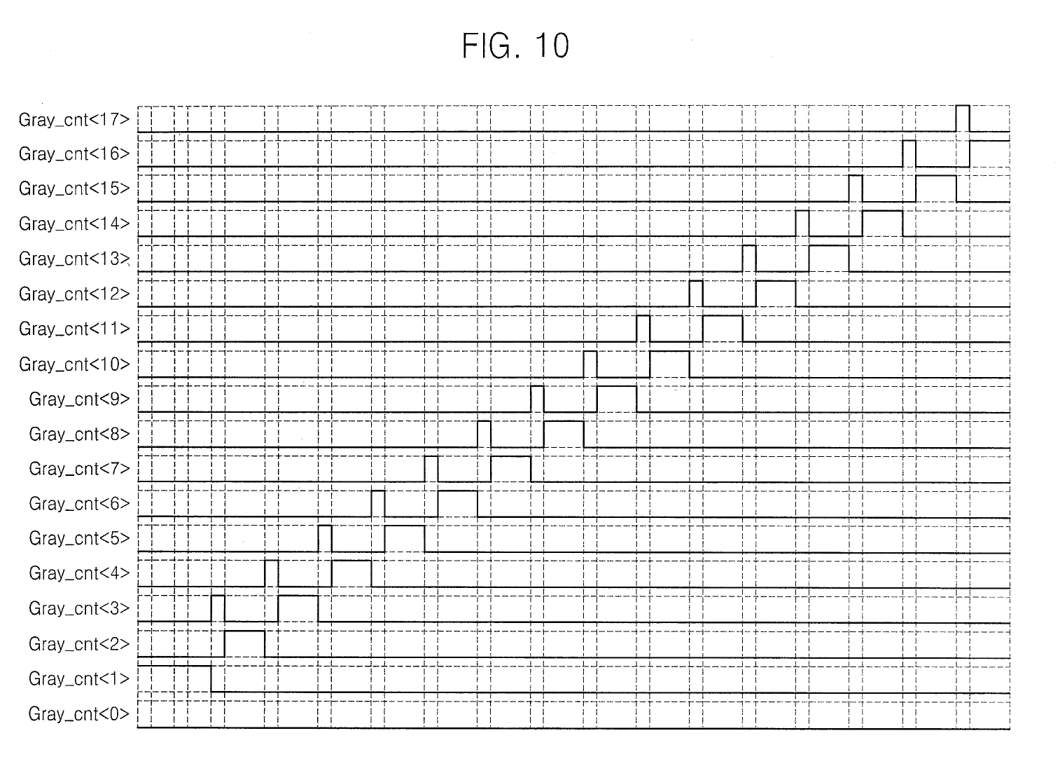

FIGS. 7 and 9 are diagrams of the ideal waveforms of the first global gamma voltage signal A1 according to different embodiments of the present inventive concepts. FIGS. 8 and 10 are diagrams of the ideal waveforms of a grayscale control signal Gray_CNT<0:17> for outputting the first global gamma voltage signal A1 illustrated in FIG. 7 and the first global gamma voltage signal A1 illustrated in FIG. 9, respectively.

FIGS. 7 and 8 show the first global gamma voltage signal A1 and the grayscale control signal Gray_CNT<0:17> in case of positive gamma. The operations of the gamma decoders 61-1 through 61-16 in case of the positive gamma will be described with reference to FIGS. 7 and 8 below.

The first gamma decoder 61-1 receives the at least one dummy voltage, e.g., V0_dummy and V15_dummy, and a first group of the grayscale voltages V0 through V15 among the 256 grayscale voltages V0 through V255 and outputs the first global gamma voltage signal A1, which includes pre-emphasis voltages and the first group of the grayscale voltages V0 through V15, in response to the grayscale control signal Gray_CNT<0:17>.

The bits in the grayscale control signal Gray_CNT<0:17> correspond to the first dummy voltage V0_dummy, the grayscale voltages V0 through V15 in the first group, and the second dummy voltage V15_dummy, respectively. For instance, the bits from the LSB Gray_CNT<0>to the most significant bit (MSB) Gray_CNT<17> in the grayscale control signal Gray_CNT<0:17> respectively correspond to the first dummy voltage V0_dummy, the grayscale voltages V0 through V15, and the second dummy voltage V15_dummy.

When one of the bits in the grayscale control signal Gray_CNT<0:17> is activated to, e.g., a high level, a corresponding voltage is selected from among the first dummy voltage V0_dummy, the grayscale voltages V0 through V15, and the second dummy voltage V15_dummy. The selected voltage is then output.

For instance, when the 4-bit digital code CODE sequentially increases from 0000 to 1111, the first gamma decoder 61-1 sequentially selects and outputs the grayscale voltages V0 through V15 from the grayscale voltage V15 to the grayscale voltage V0. At this time, before outputting each of the grayscale voltages V0 through V15, the first gamma decoder 61-1 outputs a pre-emphasis voltage higher than each grayscale voltage, which will be output following the pre-emphasis voltage for a predetermined period of time.

For instance, the first gamma decoder 61-1 outputs as a pre-emphasis voltage the grayscale voltage V13 one level higher than the grayscale voltage V14 for a predetermined period of time before outputting the grayscale voltage V14 in response to a digital code of 0001. The first gamma decoder 61-1 outputs as a pre-emphasis voltage the grayscale voltage V12 one level higher than the grayscale voltage V13 for a predetermined period of time before outputting the grayscale voltage V13 in response to a digital code of 0010. The first gamma decoder 61-1 outputs as a pre-emphasis voltage the grayscale voltage V11 one level higher than the grayscale voltage V12 for a predetermined period of time before outputting the grayscale voltage V12 in response to a digital code of 0011. In the same manner, whenever the digital code CODE increases by 1, a grayscale voltage one level higher than a target grayscale voltage to be output is output as a pre-emphasis voltage for a predetermined period of time before the target grayscale voltage is output. Lastly, before the grayscale voltage V0 is output, the first dummy voltage V0_dummy higher than the grayscale voltage V0 is output for a predetermined period of time.

For the above-described operation, a grayscale controller 63 can output the grayscale control signal Gray_CNT<0:17> illustrated in FIG. 8 in response to the digital code CODE when the 4-bit digital code CODE sequentially increases from 0000 to 1111.

Like the first gamma decoder 61-1, the second gamma decoder 61-2 receives at least one dummy voltage, e.g., V16_dummy and V31_dummy, a second group of the grayscale voltages V16 through V31 among the 256 grayscale voltages V0 through V255 and outputs the second global gamma voltage signal A2 including pre-emphasis voltages and the second group of the grayscale voltages V16 through V31 in response to the grayscale control signal Gray_CNT<0:17>. At this time, the dummy voltage V16_dummy can be the grayscale voltage V15 one level higher than the grayscale voltage V16 and the dummy voltage V31_dummy can be the grayscale voltage V32 one level lower than the grayscale voltage V31, but the present inventive concepts are not restricted to the current embodiments.

The sixteenth gamma decoder 61-16 receives at least one dummy voltage, e.g., V240_dummy and V255_dummy, a sixteenth group of the grayscale voltages V240 through V255 among the 256 grayscale voltages V0 through V255 and outputs the sixteenth global gamma voltage signal A16 including pre-emphasis voltages and the sixteenth group of the grayscale voltages V240 through V255 in response to the grayscale control signal Gray_CNT<0:17>.

The operation of the second through sixteenth gamma decoders 61-2 through 61-16 is the same as that of the first gamma decoder 61-1. Thus, detailed descriptions thereof will be omitted.

FIGS. 9 and 10 show the first global gamma voltage signal A1 and the grayscale control signal Gray_CNT<0:17> in the case of negative gamma. The operations of the gamma decoders 61-1 through 61-16 in case of the negative gamma will be described with reference to FIGS. 9 and 10 below.

The first gamma decoder 61-1 receives the at least one dummy voltage, e.g., V0_dummy and V15_dummy, and a first group of the grayscale voltages V0 through V15 among the 256 grayscale voltages V0 through V255 and outputs the first global gamma voltage signal A1 including pre-emphasis voltages and the first group of the grayscale voltages V0 through V15 in response to the grayscale control signal Gray_CNT<0:17>.

The bits in the grayscale control signal Gray_CNT<0:17> correspond to the first dummy voltage V0_dummy, the grayscale voltages V0 through V15 in the first group, and the second dummy voltage V15_dummy, respectively. When one of the bits in the grayscale control signal Gray_CNT<0:17> is activated to, e.g., a high level, a corresponding voltage is selected from among the first dummy voltage V0_dummy, the grayscale voltages V0 through V15, and the second dummy voltage V15_dummy and then output.

For instance, when the 4-bit digital code CODE sequentially increases from 0000 to 1111, the first gamma decoder 61-1 sequentially selects and outputs the grayscale voltages V0 through V15 from the grayscale voltage V0 to the grayscale voltage V15. At this time, before outputting each of the grayscale voltages V0 through V15, the first gamma decoder 61-1 outputs a pre-emphasis voltage lower than each grayscale voltage, which will be output following the pre-emphasis voltage, for a predetermined period of time.

For instance, the first gamma decoder 61-1 outputs as a pre-emphasis voltage the grayscale voltage V2 one level lower than the grayscale voltage V1 for a predetermined period of time before outputting the grayscale voltage V1 in response to a digital code of 0001. The first gamma decoder 61-1 outputs as a pre-emphasis voltage the grayscale voltage V3 one level lower than the grayscale voltage V2 for a predetermined period of time before outputting the grayscale voltage V2 in response to a digital code of 0010. The first gamma decoder 61-1 outputs as a pre-emphasis voltage the grayscale voltage V4 one level lower than the grayscale voltage V3 for a predetermined period of time before outputting the grayscale voltage V3 in response to a digital code of 0011. In the same manner, whenever the digital code CODE increases by 1, a grayscale voltage one level lower than a target grayscale voltage is output as a pre-emphasis voltage for a predetermined period of time before the target grayscale voltage is output. Lastly, before the grayscale voltage V15 is output, the second dummy voltage V15_dummy lower than the grayscale voltage V15 is output for a predetermined period of time.

For the above-described operation, the grayscale controller 63 can output the grayscale control signal Gray_CNT<0:17> illustrated in FIG. 10 in response to the digital code CODE when the 4-bit digital code CODE sequentially increases from 0000 to 1111.

Like the first gamma decoder 61-1, the second gamma decoder 61-2 receives at least one dummy voltage, e.g., V16_dummy and V31_dummy, the second group of the grayscale voltages V16 through V31 among the 256 grayscale voltages V0 through V255 and outputs the second global gamma voltage signal A2 including pre-emphasis voltages and the second group of the grayscale voltages V16 through V31 in response to the grayscale control signal Gray_CNT<0:17>. Here, the dummy voltage V16_dummy can be the grayscale voltage V15 that is one level higher than the grayscale voltage V16. The dummy voltage V31_dummy can be the grayscale voltage V32 one level lower than the grayscale voltage V31; however, the present inventive concepts are not restricted to the current embodiments.

The sixteenth gamma decoder 61-16 receives at least one dummy voltage, e.g., V240_dummy, V255_dummy and a sixteenth group of the grayscale voltages V240 through V255 among the 256 grayscale voltages V0 through V255, and outputs the sixteenth global gamma voltage signal A16 including pre-emphasis voltages and the sixteenth group of the grayscale voltages V240 through V255 in response to the grayscale control signal Gray_CNT<0:17>.

The operation of the second through sixteenth gamma decoders 61-2 through 61-16 is the same as that of the first gamma decoder 61-1. Thus, detailed descriptions thereof will be omitted.

As described above, each of the gamma decoders 61-1 through 61-16 receives “m” grayscale voltages among the 256 grayscale voltages and at least one dummy voltage and sequentially outputs the “m” grayscale voltages to a global gamma line. At this time, a pre-emphasis voltage is output before each grayscale voltage is output.

The outputs of the gamma decoders 61-1 through 61-16, respectively, are input to each of the channel drivers 500 without passing through a gamma amplifier or a buffer.

As described above, according to some embodiments of the present inventive concepts, since the gamma decoders 61-1 through 61-16 output a pre-emphasis voltage higher or lower than a grayscale voltage before outputting the grayscale voltage, the grayscale voltage can be driven to a channel driver without a gamma amplifier or a buffer. Accordingly, non-monotonicity caused by global amplifiers is removed. In addition, since the global amplifiers occupying a large area and consuming a large amount of power is removed, the size and the power consumption of a source driver and a display device including the source driver are reduced.

FIG. 5 is a schematic block diagram of the channel driver 500 illustrated in FIG. 2 according to some embodiments of the present inventive concepts.

Referring to FIG. 5, the channel driver 500 includes a memory 510, a data latch 520, a data comparator 530, a first level shifter 541, a second level shifter 542, a decoder 550, and an output circuit 560.

The data latch 520 receives and stores channel data (e.g., DATA<7:0>) of a predetermined number of (e.g., 8) bits corresponding to a channel (e.g., the first data line S1) among image data stored in the memory 510. The data latch 520 divides the channel data into an upper signal (e.g., upper 4 bits DU<7:4>) and a lower signal (e.g., lower 4 bits DL<3:0>) and separately outputs the upper signal DU<7:4> and the lower signal DL<3:0>.

The upper signal DU<7:4> is input to the first level shifter 541. The lower signal DL<3:0> is input to the data comparator 530.

The data comparator 530 compares the PWM signals Track<0:15> with the lower signal DL<3:0> of the channel data and selects and outputs a PWM signal matching the lower signal DL<3:0> as a selected PWM signal TP.

For instance, the lower 4-bit data DL<3:0> among the channel data stored in the data latch 520 is input to the data comparator 530 and then the PWM signals Track<0:15> are input to the data comparator 530. The data comparator 530 outputs as the selected PWM signal TP one PWM signal selected from among the 16 PWM signals Track<0:15> in response to the lower signal DL<3:0> of the channel data.

The first and second level shifters 541 and 542 shift up the voltage level of an input signal. For instance, the selected PWM signal TP is at a logic low level (e.g., VDD). A preferable voltage of 4 to 6 V is required to control switches 561 through 564 in the output circuit 560. Therefore, a level-up shifter may be required.

Accordingly, the second level shifter 542 shifts the voltage level of the selected PWM signal TP at the logic low level to a predetermined voltage level (e.g., 4 to 6 V). In addition, the second level shifter 542 can include a switch timing controller (not shown) which controls timing of switch control signals S0, S1 and S2.

The first level shifter 541 shifts the voltage level of the upper signal DU<7:4> of the channel data. For instance, the upper signal DU<7:4> of 4 bits output from the data latch 520 is at a logic high level (VDD) and 4 to 6 V is needed to control the 4-bit decoder 550. Accordingly, the first level shifter 541 shifts the voltage level of the upper signal DU<7:4> at the logic high level to a predetermined voltage level (e.g., 4 to 6 V).

The 4-bit decoder 550 selects one of the 16 global gamma voltage signals A1 through A16 in response to the upper signal DU<7:4> of the channel data.

The 4-bit decoder 550 can include a plurality of switches to selectively transmit “k” (e.g., 16) global gamma voltage signals A1 through A16 to the output circuit 560 as an input signal Vin. Each of the switches can be positioned between a global gamma voltage signal line and an input node of the output circuit 560 and closed or opened in response to an output signal of the first level shifter 541, i.e., a level-shifted upper signal.

Since the switches in the 4-bit decoder 550 are controlled by the upper 4 bits among the 8 bits of the channel data, one of the “k” global gamma voltage signals A1 through A16, each of which includes a grayscale voltage and a pre-emphasis voltage one level higher or lower than the grayscale voltage prior to the grayscale voltage, is transmitted to the input node of the output circuit 560.

In other words, the decoder 550 selectively outputs one of the “k” global gamma voltage signals A1 through A16 in response to the upper 4 bits DU<7:4>. The upper 4 bits DU<7:4> are 0000, 0001, 0010 or 1111, the decoder 550 outputs the first, second, third or sixteenth global gamma voltage signal A1, A2, A3 or A16, respectively.

The output circuit 560 includes a capacitor C_{H}, the switches 561 through 564, and an operational amplifier 570. The output circuit 560 performs a sampling/holding operation on a particular grayscale voltage level among a plurality of grayscale voltage levels included in the global gamma voltage signal Vin output from the decoder 550 using the capacitor C_{H} and the switches 561 through 564 and amplifies a voltage held at the capacitor C_{H} by the sampling/holding operation using the operational amplifier 570. Each of the switches 561 through 564 can be implemented by a transmission gate or metal oxide semiconductor field effect transistor (MOSFET) or related electronic circuit.

The disclosure of Korean Patent Publication No. 10-2010-0116288, incorporated herein by reference in its entirety, is referred to for the structure and the operation of the channel driver 500.

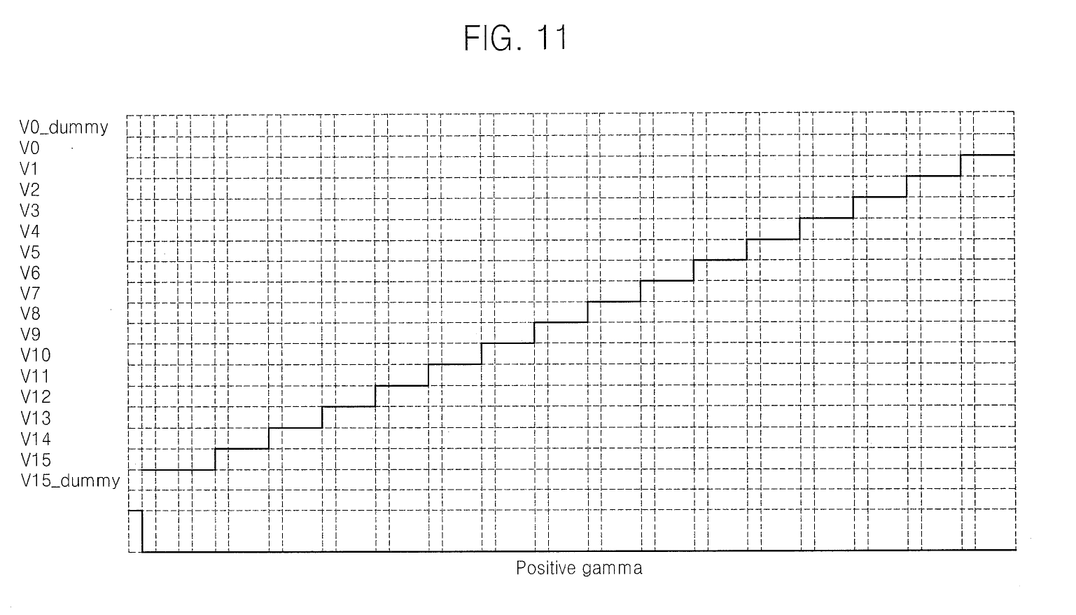

FIG. 11 is a diagram of an ideal waveform of a first global gamma voltage signal in a case where a positive gamma is produced in a comparative example. As shown in FIG. 11, the grayscale voltages V0 through V15 are just sequentially output from the grayscale voltage V15 to the grayscale voltage V0 in the first global gamma voltage signal, but no pre-emphasis voltages exist.

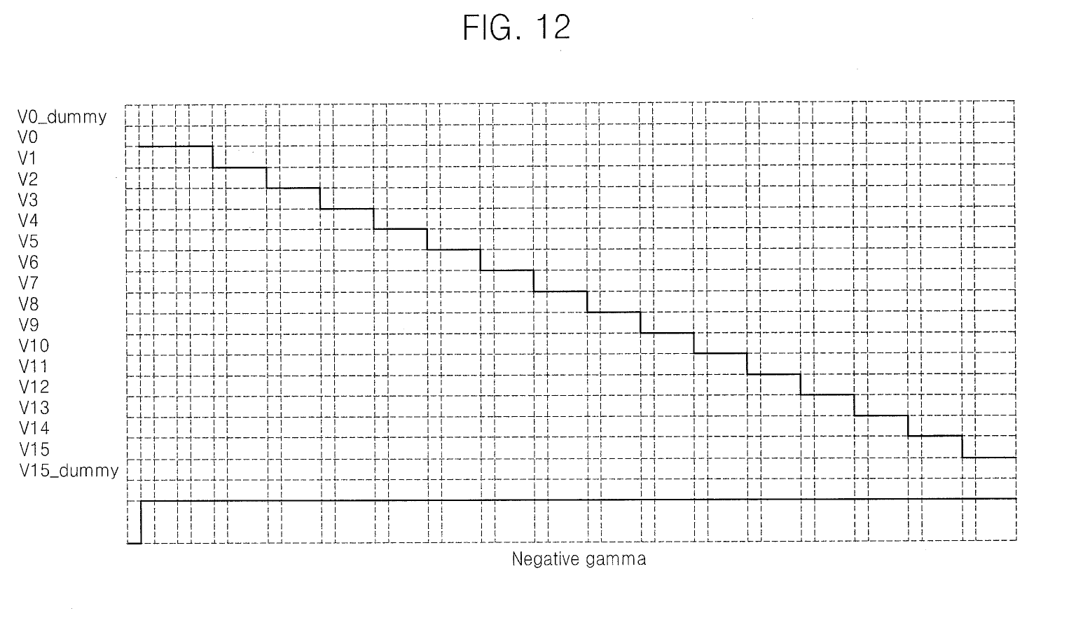

FIG. 12 is a diagram of an ideal waveform of a first global gamma voltage signal in a case where a negative gamma is produced in a comparative example. As shown in FIG. 12, the grayscale voltages V0 through V15 are sequentially output from the grayscale voltage V0 to the grayscale voltage V15 in the first global gamma voltage signal. However, no pre-emphasis voltages are present.

As described above, a gamma amplifier is necessary in order to drive the first global gamma voltage signal to channel drivers in the comparison examples illustrated in FIGS. 11 and 12. In this case, non-monotonicity and an increase in an area and power consumption can occur due to the presence of the gamma amplifier.

On the contrary, according to some embodiments of the present inventive concepts, a pre-emphasis voltage is output before a grayscale voltage is output in a global gamma voltage signal, so that the global gamma voltage signal is satisfactorily driven to channel drivers.

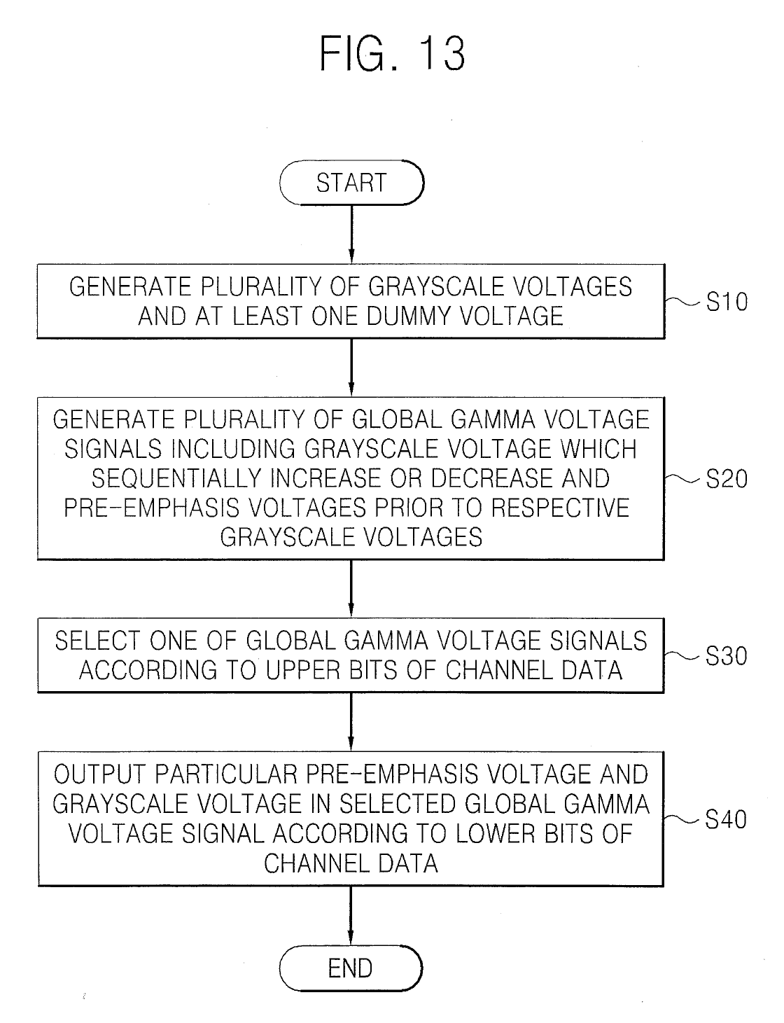

FIG. 13 is a flowchart of a method of driving a display device according to some embodiments of the present inventive concepts. The method illustrated in FIG. 13 can be performed by the source driver 100 illustrated in FIGS. 2 through 5.

The grayscale voltage generator 190 in the source driver 100 generates a plurality of grayscale voltages and at least one dummy voltage in operation S10. The at least one dummy voltage can be provided from an external device or internally generated by a charge pump.

The global gamma voltage signal generator 195 receives the plurality of grayscale voltages and the at least one dummy voltage, and generates a plurality of global gamma voltage signals. In operation S20, the gamma voltage signals include grayscale voltages that sequentially increase or decrease, for example, described herein. The gamma voltage signals also include pre-emphasis voltages that are output prior to their respective grayscale voltages.

In operation S30, each channel driver 500 in the source driver 100 divides latched channel data into the upper bits DU<7:4> and the lower bits DL<3:0> and selects one of the global gamma voltage signals according to the upper bits DU<7:4> of the channel data. In operation S40, the channel driver 500 outputs a particular grayscale voltage in the selected global gamma voltage signal to a data line in response to the lower bits DL<3:0> of the channel data.

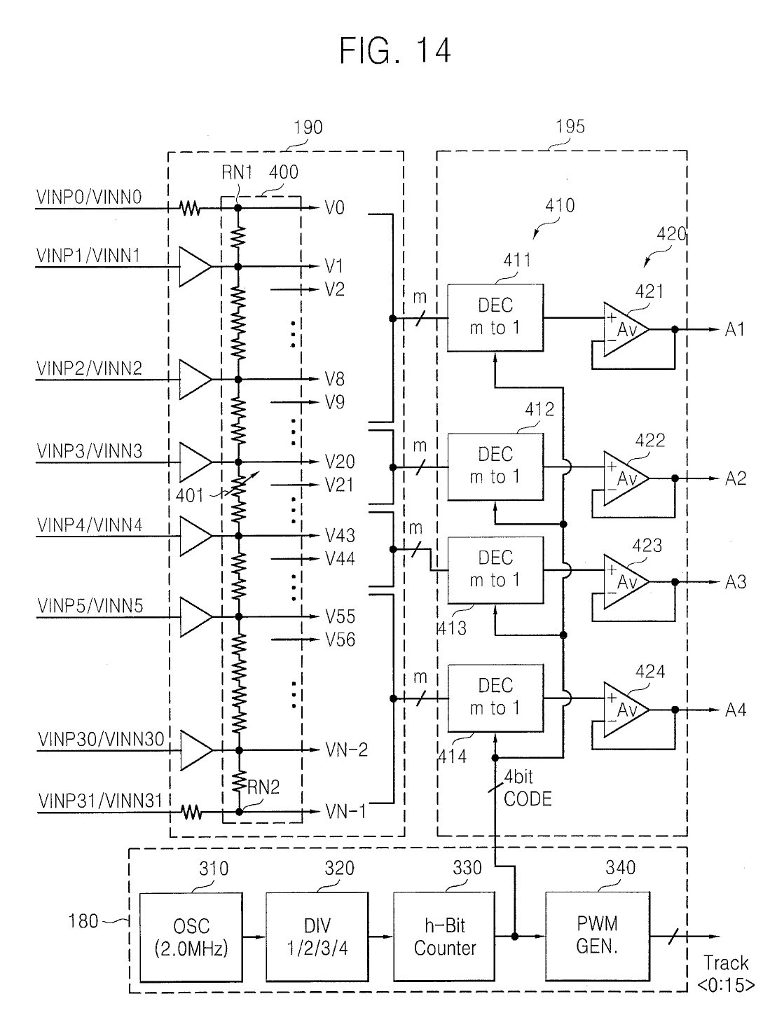

FIG. 14 is a diagram of the global block 170 illustrated in FIG. 3 according to other embodiments of the present inventive concepts.

The grayscale voltage generator 190 receives at least two reference voltages VINP0 through VINP31 or VINN0 through VINN31 and generates a plurality of N grayscale voltages V0 through VN−1, where N is a natural number. The grayscale voltage generator 190 can include a resistor string 400.

In the current embodiment, the grayscale voltage generator 190 receives the reference voltages VINP0 through VINP31 or VINN0 through VINN31, respectively, each at 32 levels. The grayscale voltage generator 190 generates N (e.g., 64, 128 or 256) grayscale voltages V0 through VN−1. It is assumed that N is 64 and 64-level grayscale voltages V0 through V63 sequentially decrease from the grayscale voltage V0 to the grayscale voltage V63. However, the present inventive concepts are not restricted to the current embodiments and the gap between adjacent grayscale voltages does not need to be constant. In other embodiments of the present inventive concepts, the 64-level grayscale voltages V0 through V63 can sequentially increase from the grayscale voltage V0 to the grayscale voltage V63.

The resistor string 400 includes a plurality of resistance elements connected in series between a node NR1 receiving one reference voltage and a node NR2 receiving another reference voltage. The resistor string 400 generates a plurality of (e.g., 64) grayscale voltages (e.g., V0 through V63) between the two reference voltages. Among the plurality of resistance elements in the resistor string 400 at least one resistance element 401 can have a variable effective resistance. The 64 grayscale voltages can also be referred to as 64 gray DC voltages.

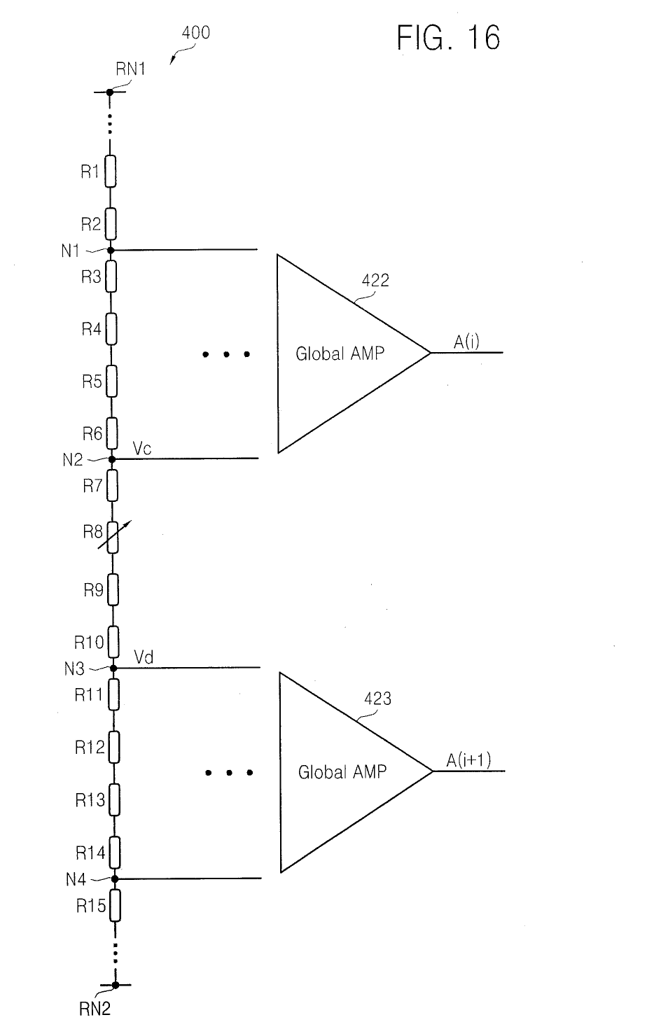

The structure and the operation of the resistor string 400 will be described in detail with reference to FIGS. 16 through 22 and FIGS. 24 through 27.

Returning to FIG. 14, the global gamma voltage signal generator 195 includes “k” gamma decoders 411 through 414 and “k” gamma amplifiers 421 through 424.

The global gamma voltage signal generator 195 generates “k” global gamma voltage signals A1 through Ak according to a digital code CODE output from the code generation block 180. Here, “k” is 2 or a natural number greater than 2. In the current embodiments, “k” is 4, but the present inventive concepts are not restricted to the current embodiments.

Each of the global gamma voltage signals A1 through Ak includes a plurality of “m” grayscale voltages, where “m” is a natural number. Here, “m” can be the number of grayscale voltages (e.g., 64) divided by “k”. Each of the “k” global gamma voltage signals A1 through Ak includes m-level grayscale voltages which sequentially increase or decrease.

The global gamma voltage signal generator 195 includes the “k (4 in the current embodiments)” gamma decoders 411 through 414. In the current embodiments, each of the k, i.e., 4, gamma decoders 411 through 414 can be implemented by an m-to-1 decoder that receives “m (e.g., 16 where “m” is a natural number)” input signals, i.e., “m” grayscale voltages, and outputs a single global gamma voltage signal; however, the present inventive concepts are not restricted to the current embodiments. Here, “m” is 2” and “m” is 16 when “h” is 4; however, the present inventive concepts are not restricted thereto.

Each of the gamma decoders 411 through 414 receives m-level grayscale voltages (referred to as first through m-th grayscale voltages for clarity of the description) among the entire grayscale voltages V0 through VN−1 and sequentially selects and outputs the first through m-th grayscale voltages in response to the digital code CODE.

Each of the gamma decoders 411 through 414 can be a 4-bit digital-to-analog converter (DAC), which selects and outputs a grayscale voltage corresponding to the 4-bit digital code CODE among the 16 grayscale voltages.

The first gamma decoder 411 receives a first group of the grayscale voltages V0 through V15 among the 64 grayscale voltages V0 through V63 and outputs the first global gamma voltage signal A1, which includes the first group of the grayscale voltages V0 through V15 that have been decoded according to the 4-bit digital code CODE. For instance, when the 4-bit digital code CODE sequentially increases from 0000 to 1111, the first gamma decoder 411 outputs the first global gamma voltage signal A1 from the grayscale voltage V0 to the grayscale voltage V15. The first global gamma voltage signal A1 have a sequentially decreasing step waveform or a sequentially increasing step waveform.

The second gamma decoder 412 receives a second group of the grayscale voltages V16 through V31 among the 64 grayscale voltages V0 through V63 of the divided range of voltages between nodes RN1 and RN2. The second gamma decoder 412 can output the second step-wave global gamma voltage signal A2, which includes the second group of the grayscale voltages V16 through V31 that have been decoded according to the 4-bit digital code CODE. For instance, when the 4-bit digital code CODE sequentially increases from 0000 to 1111, the second gamma decoder 412 outputs the second global gamma voltage signal A2, whether decreasing sequentially or increasing sequentially, from the grayscale voltage V16 to the grayscale voltage V31.

The third gamma decoder 413 is similar to the first and second gamma decoders 411 and 412 in that the third gamma decoder 413 receives a group of the grayscale voltages, specifically, a third group of grayscale voltages V32 through V47, among the 64 grayscale voltages V0 through V63. The third gamma decoder 413 outputs the third step-wave global gamma voltage signal A3, which includes the third group of the grayscale voltages V32 through V47 that have been decoded according to the 4-bit digital code CODE. The fourth gamma decoder 414 in a similar manner receives a second group of the grayscale voltages V48 through V63 among the 64 grayscale voltages V0 through V63 and outputs the fourth step-wave global gamma voltage signal A4 including the fourth group of the grayscale voltages V48 through V63 that have been decoded according to the 4-bit digital code CODE.

The gamma amplifiers 421 through 424 respectively buffer the global gamma voltage signals A1 through A4 respectively output from the gamma decoders 441 through 444. Each of the gamma amplifiers 421 through 424 can be implemented as a unit gain buffer and can include an operational amplifier. As described above, the PWM signals Track<0:15> generated by the code generation block 180 and the global gamma voltage signals A1 through A4 output from the global gamma voltage signal generator 195 are provided to each of the channel drivers 500′.

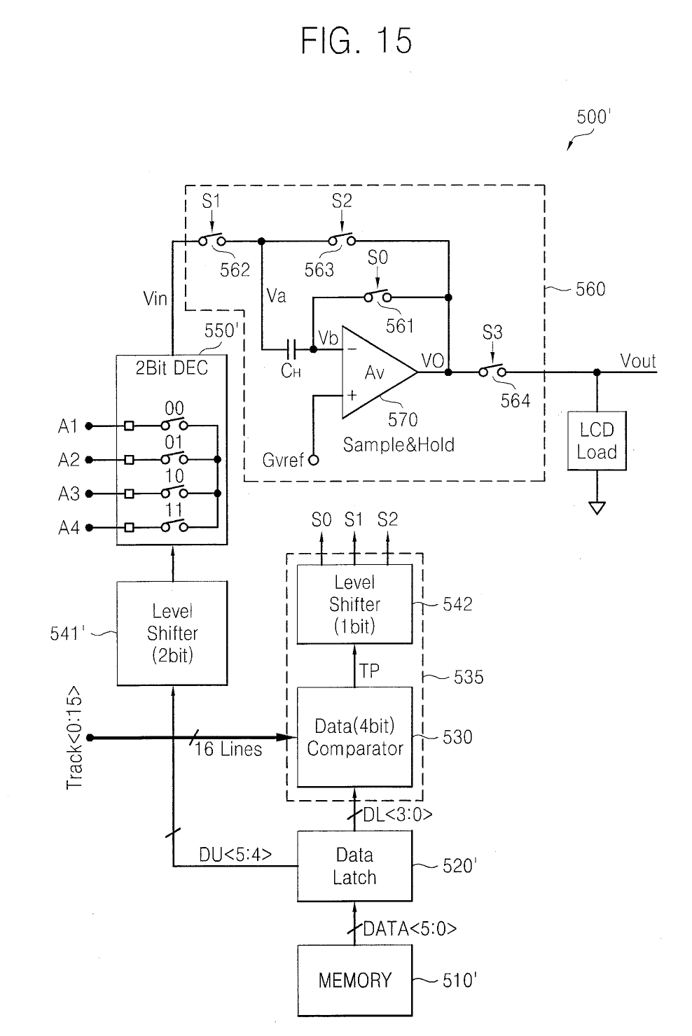

FIG. 15 is a schematic block diagram of the channel driver 500′ illustrated in FIG. 2 according to other embodiments of the present inventive concepts. Referring to FIG. 15, the channel driver 500′ includes a memory 510′, a data latch 520′, the data comparator 530, a first level shifter 541′, the second level shifter 542, a decoder 550′, and the output circuit 560.

Since the channel driver 500′ illustrated in FIG. 15 is similar to the channel driver 500 illustrated in FIG. 5, the differences therebetween will be described. In contrast to the channel driver 500 illustrated in FIG. 5 which processes 8-bit data DATA<7:0>, the channel driver 500′ illustrated in FIG. 15 processes 6-bit data DATA<5:0>.

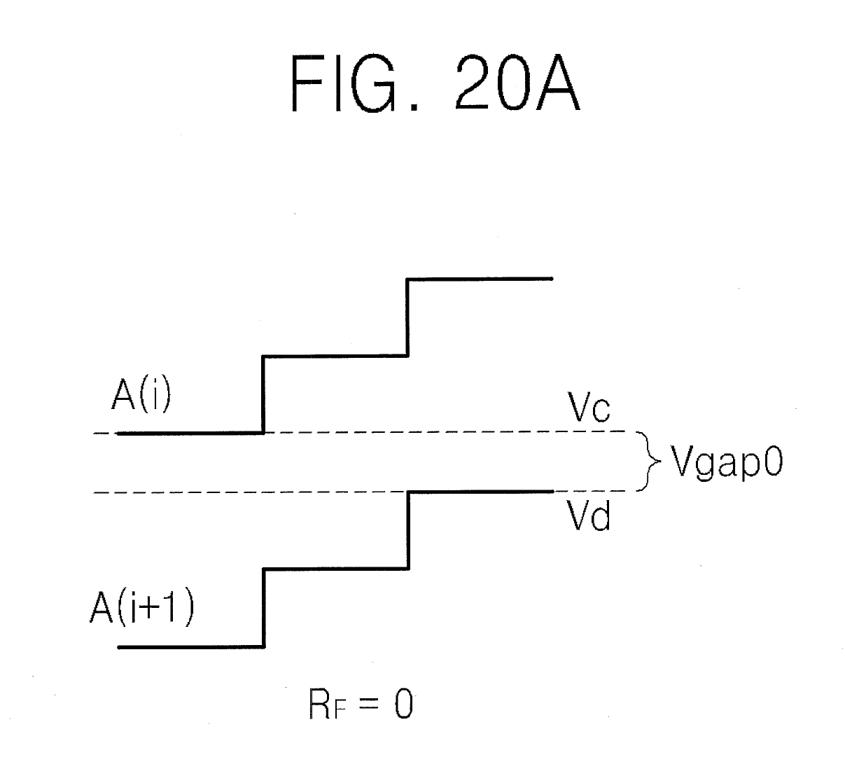

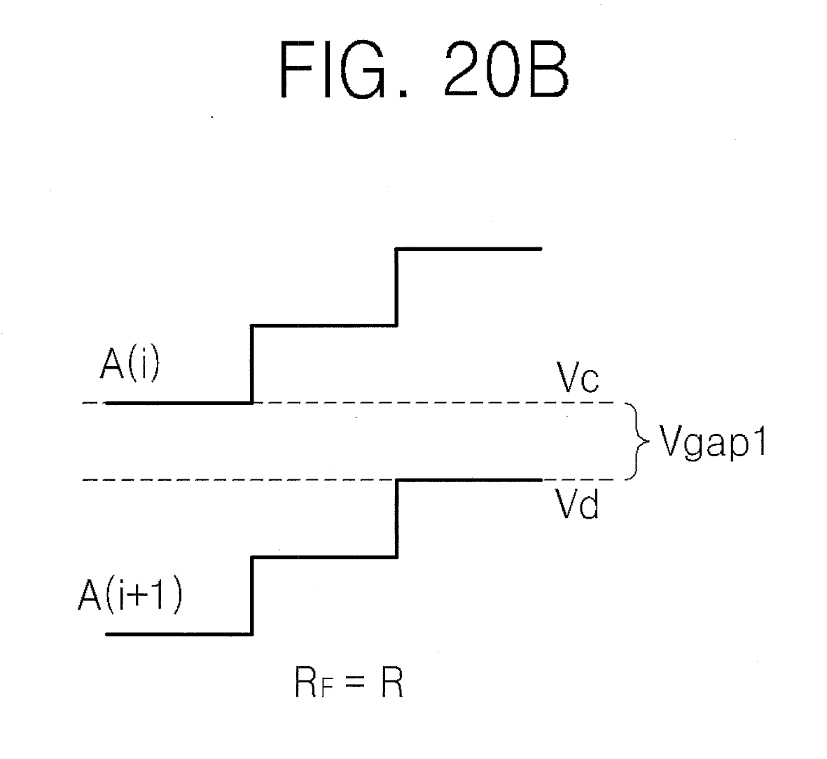

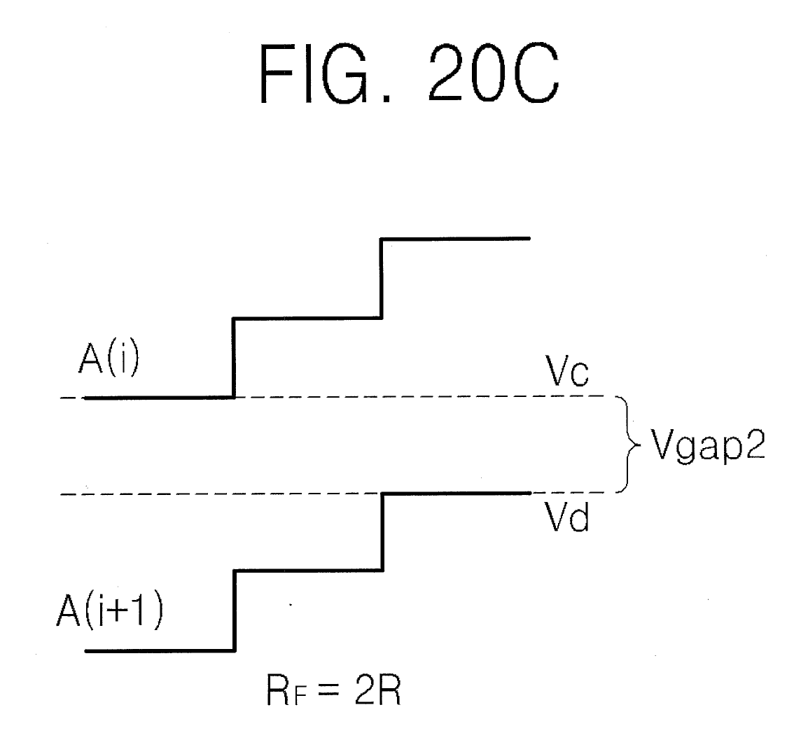

FIG. 16 is a detailed diagram of the resistor string 400 illustrated in FIG. 14. Referring to FIG. 16, the resistor string 400 can include a plurality of resistance elements R1 through R15 connected in series between the first reference node RN1 and the second reference node RN2. Although only some resistance elements R1 through R15 are illustrated in FIG. 16 for clarity of the description, the number of resistance elements can be changed freely. For example, the resistance elements R1 through R15 can have the same or different resistance values. In the embodiments illustrated in FIG. 16, when the effective resistance of at least one resistance element, e.g. R8, among the resistance elements R7 through R10 connected between a first transition node N2 and a second transition node N3 is changed, a voltage difference between the transition nodes N2 and N3 can be controlled. The transition nodes N2, N3 are the nodes that respectively output boundary voltages respectively belonging to different global gamma voltage signals A(i) and A(i+1). For instance, when the global gamma voltage signals A(i) and A(i+1) increase step-by-step as shown in FIG. 20, the lowest grayscale voltage in the global gamma voltage signal A(i) and the highest grayscale voltage in the global gamma voltage signal A(i+1) are the boundary voltages, and the nodes N2 and N3 outputting the boundary voltages are transition nodes.

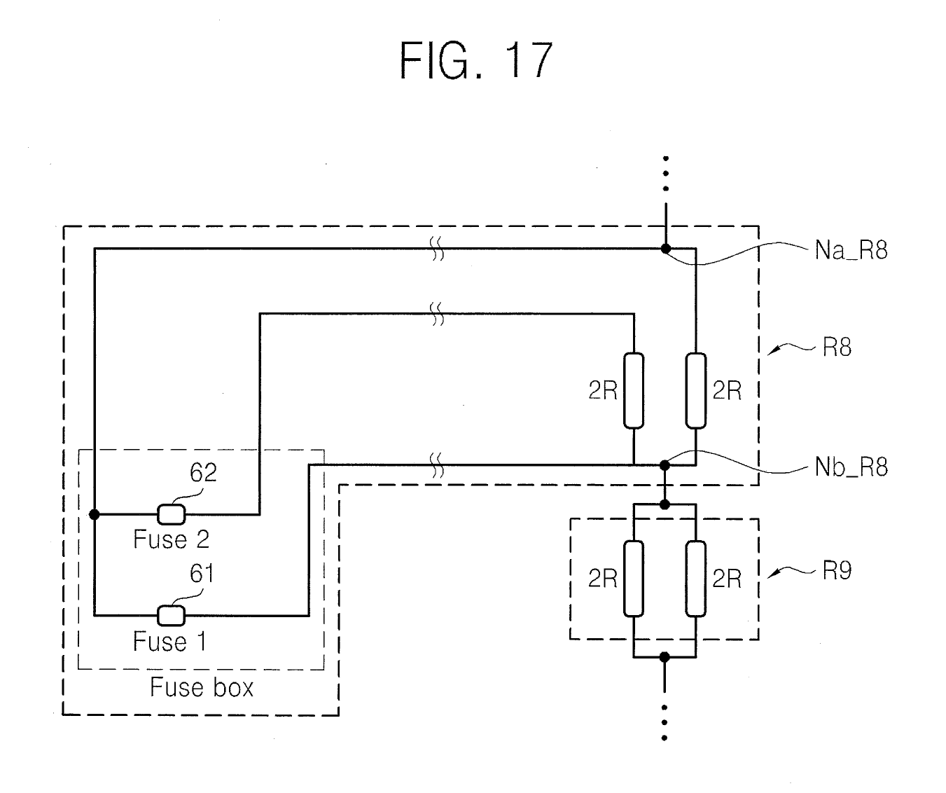

FIG. 17 is a circuit diagram showing the resistance element R8 illustrated in FIG. 16, which has variable effective resistance. Referring to FIG. 17, the resistance element R8 can include a unit resistor 2R and at least one fuse 61 and 62. A first unit resistor 2R and the first fuse 61 can be connected in parallel between a first node Na_R8 and a second node Nb_R8. In addition, a second unit resistor 2R and the second fuse 62 can be connected in series between the first node Na_R8 and the second node Nb R8. The effective resistance of the resistance element R8 is changed depending on whether the first and second fuses 61 and 62 are cut.

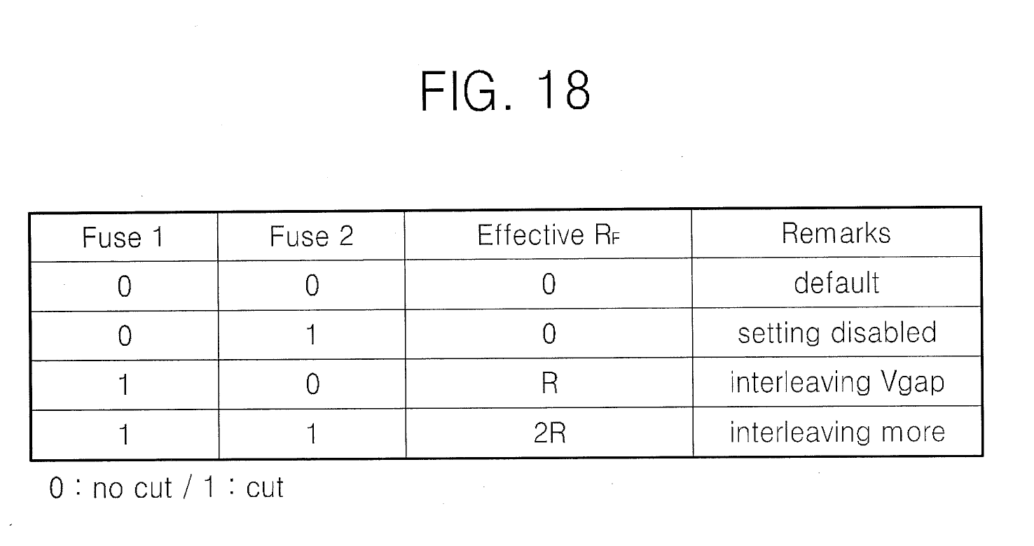

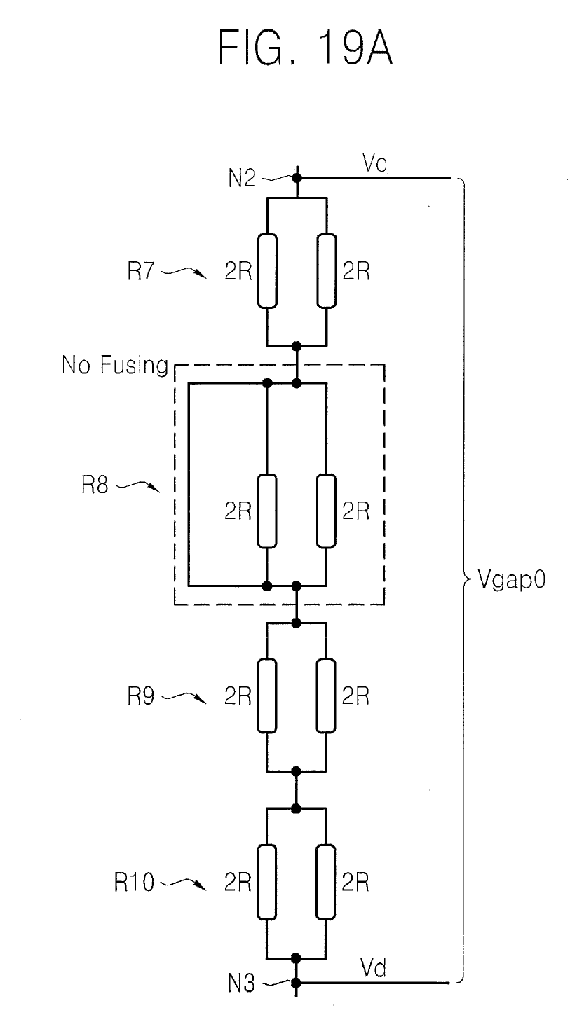

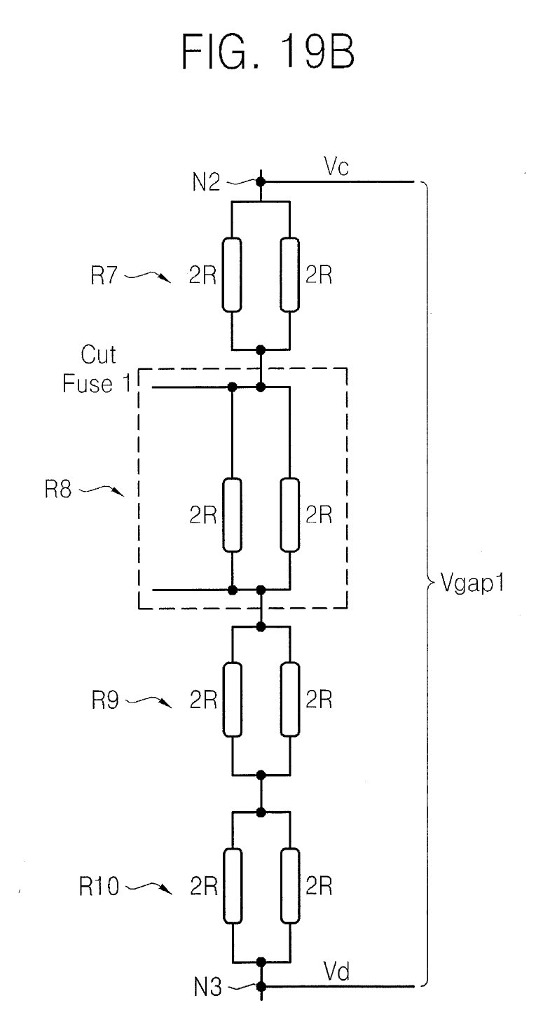

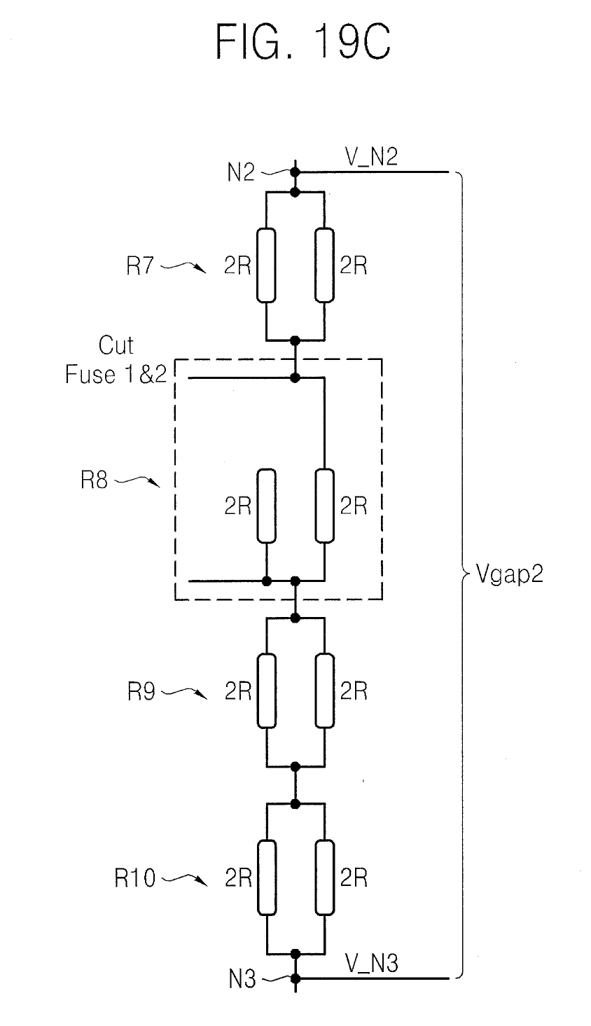

FIG. 18 is a table showing an effective resistance R_{F} having a value depending on whether the first and second fuses 61 and 62 are cut in the resistance element R8 illustrated in FIG. 17. FIG. 19A is a diagram illustrating the connection when either of the first and second fuses 61 and 62 are not cut in the resistance element R8 illustrated in FIG. 17. When neither of the first and second fuses 61 and 62 is cut, the effective resistance R_{F} is 0. A voltage difference between the node N2 and the node N3 at this time is referred to as a first voltage gap Vgap0.

A case where only the second fuse 62 is cut is not illustrated in the circuit drawings, but the effective resistance R_{F} of the resistance element R8 is 0 in this case.

FIG. 19B is a diagram showing the connection when only the first fuse 61 is cut in the resistance element R8 illustrated in FIG. 17. When only the first fuse 61 is cut, the two unit resistors 2R are connected in parallel in the resistance element R8. Here, the effective resistance R_{F} of the resistance element R8 is R. A voltage difference between the node N2 and the node N3 at this time is referred to as a second voltage gap Vgap1. In this case, the second voltage gap Vgap1 is greater than the first voltage gap Vgap0.

FIG. 19C is a diagram showing the connection when all of the first and second fuses 61 and 62 are cut in the resistance element R8 illustrated in FIG. 17. When all of the first and second fuses 61 and 62 are cut, only one unit resistor 2R is connected in the resistance element R8, so the effective resistance R_{F} of the resistance element R8 is 2R. Here, a voltage difference between the node N2 and the node N3 at this time is referred to as a third voltage gap Vgap2. In this case, the third voltage gap Vgap2 is greater than the second voltage gap Vgap1.

FIGS. 20A through 20C are diagrams of the global gamma voltage signals A(i) and A(i+1) having the first, second and third voltage gaps Vgap0 through Vgap2, respectively.

Referring to FIGS. 20A through 20C, the first through third voltage gaps Vgap0 through Vgap2 can include differences between the lowest grayscale voltage in the i-th (e.g., second) global gamma voltage signal A(i) and the highest grayscale voltage in the (i+1)-th (e.g., third) global gamma voltage signal A(i+1).

As described above, when the resistance element R8 is configured to include a fuse so that the effective resistance R_{F} of the resistance element R8 is changed depending on the cut-off of the fuse, a difference between grayscale voltages can be controlled. In particular, a voltage difference between a signal input to one global amplifier, e.g., 422 and a signal input to an adjacent global amplifier, e.g. 423 is controlled, so that a voltage difference between output signals, i.e. A(i) and A(i+1) of the two global amplifiers 422 and 423 is controlled to have a desired value. Accordingly, non-monotonicity is reduced that would otherwise be caused by different offsets between the two global amplifiers 422 and 423.

In the current embodiments, a fuse is initially in a connected state and can be subsequently cut; however, the present inventive concepts are not restricted to the current embodiments. For instance, the fuse can be initially in a cut-off (or disconnected) state and can be connected afterwards through the conduction of current. In addition, the connection between a resistor and a fuse in a resistance element can be changed in various ways.

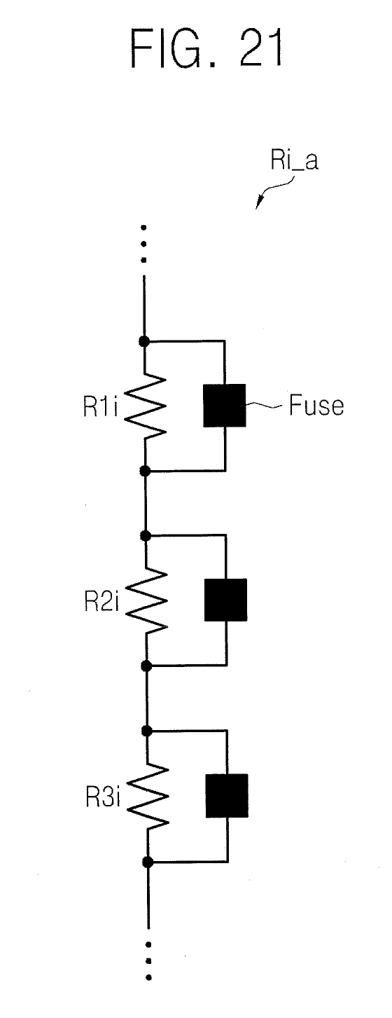

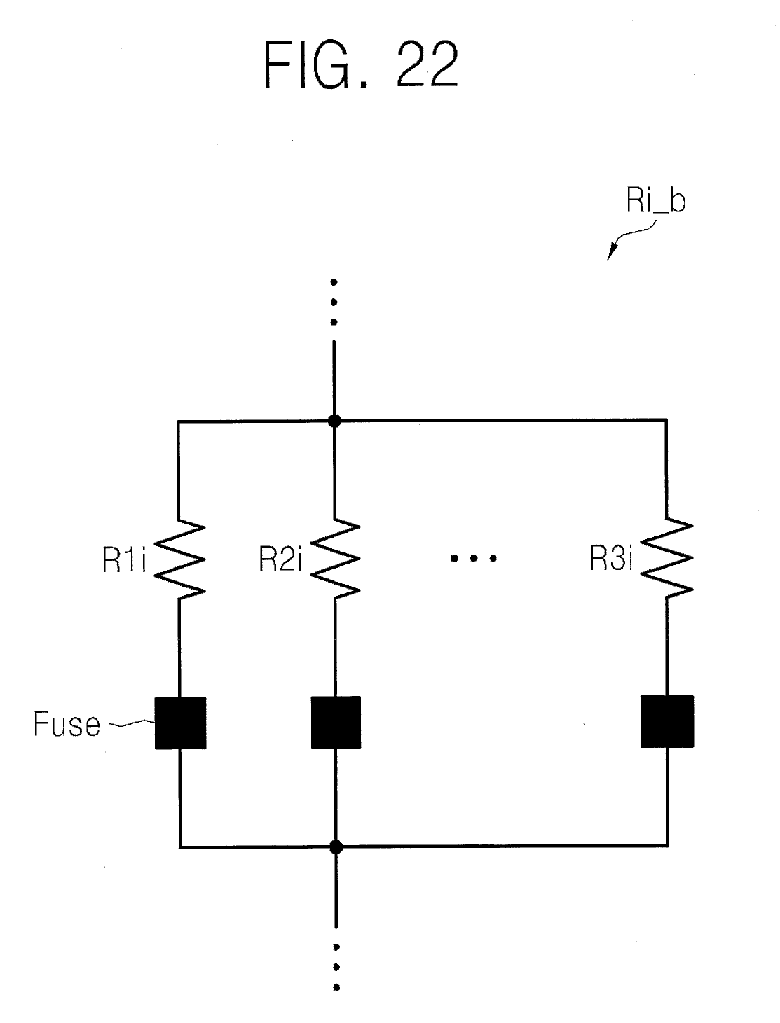

FIGS. 21 and 22 are circuit diagrams of a resistance element according to different embodiments of the present inventive concepts.

Referring to FIG. 21, a resistance element Ri_a includes a plurality of resistors R1i through R3i and a plurality of fuses, each connected in parallel with a respective resistor R1i through R3i. The effective resistance of the resistance element Ri_a can be controlled by the state of the fuses, i.e. on/off states. For instance, when the fuse connected in parallel with the first resistor R1i is on, i.e. a path is formed through the fuse, and the fuses connected in parallel with the remaining resistors R2i and R3i are off, i.e. a path through the fuses is broken, the effective resistance of the resistance element Ri_a is defined by the sum of the resistance of the second resistor R2i and the resistance of the third resistor R3i. Consequently, the effective resistance of the resistance element Ri_a is changed by selectively changing the state of the fuses, i.e., on or off.

Referring to FIG. 22, a resistance element Ri_b includes a plurality of resistors R1i through R3i and fuses connected in series with the respective resistors R1i through R3i. The effective resistance of the resistance element Ri_b can be controlled by on/off of the fuses. For instance, when the fuse connected in series with the first resistor R1i is on (i.e. a path is formed through the fuse) and the fuses connected in series with the remaining resistors R2i and R3i are off, i.e., a path through the fuses is broken, the effective resistance of the resistance element Ri_b is defined by only the first resistor R1i.

Consequently, the effective resistance of the resistance element Ri_b is changed by selectively turning on or off the fuses connected in series with the resistors R1i through R3i, respectively.

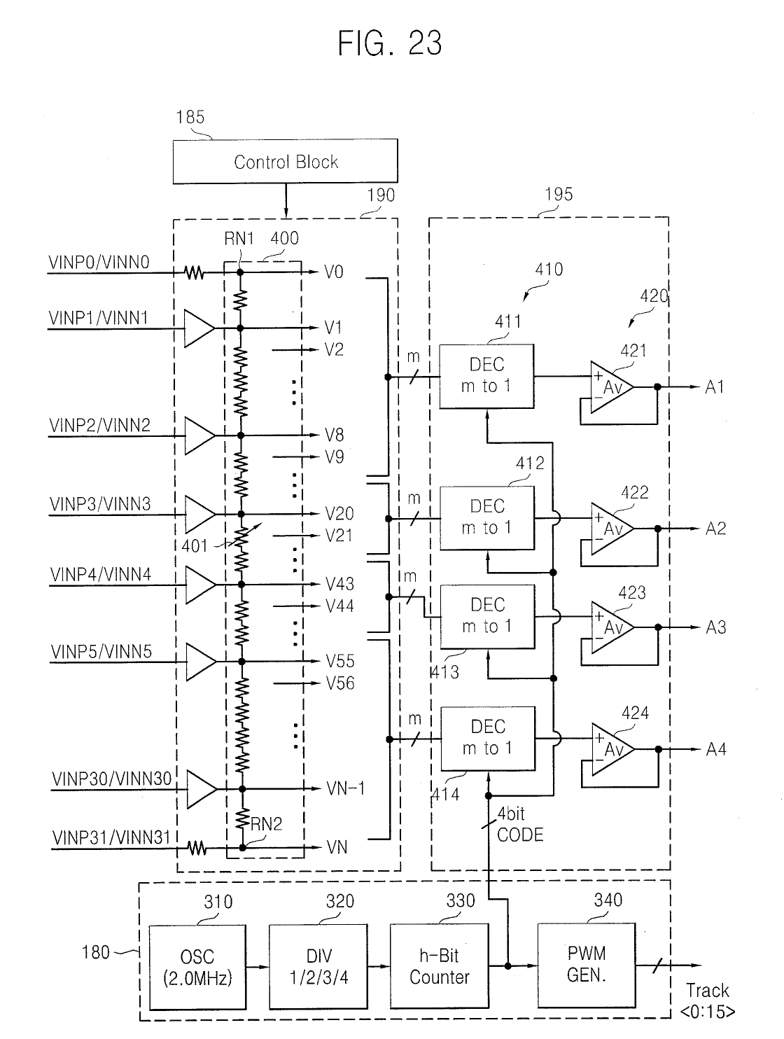

FIG. 23 is a diagram showing the global block 170 illustrated in FIG. 3 according to further embodiments of the present inventive concepts.

Since the global block 170 illustrated in FIG. 23 has a similar structure to the global block 170 illustrated in FIG. 14, differences therebetween will be described to avoid redundancy. Compared to the global block 170 illustrated in FIG. 14, the global block 170 illustrated in FIG. 23 further includes a control block 185. The control block 185 can output a resistance control signal to the grayscale voltage generator 190 to change the effective resistance of at least one resistance element (e.g., 401) among a plurality of resistance elements in the resistor string 400.

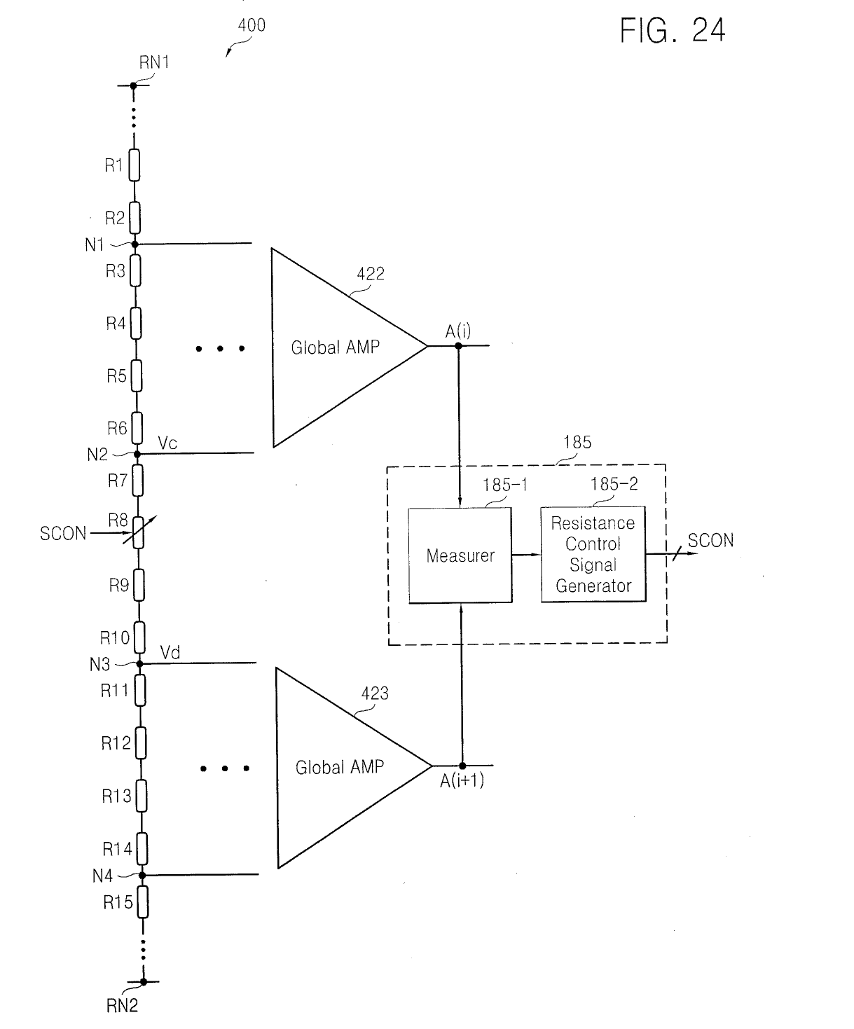

FIG. 24 is a diagram of a detailed structure of the resistance string 400 and the control block 185 illustrated in FIG. 23. Since the structure of the resistor string 400 illustrated in FIG. 24 is the same as that of the resistor string 400 illustrated in FIG. 16, the description thereof will be omitted to avoid redundancy. The effective resistance of the resistance element R8 illustrated in FIG. 24 is just changed in response to a resistance control signal SCON.

The control block 185 can include a measurer 185-1 and a resistance control signal generator 185-2. The measurer 185-1 measures a voltage difference between global gamma voltage signals (e.g., A(i) and A(i+1)) output from the two gamma amplifiers 422 and 423. The resistance control signal generator 185-2 generates the resistance control signal SCON for changing the effective resistance of a resistance element (e.g., R8) in the resistor string 400 based on the voltage difference measured by the measurer 185-1. The resistance control signal SCON can be a digital signal having a plurality of bits.

In other embodiments, the control block 185 can include a memory, e.g., a register (not shown) storing the predetermined resistance control signal SCON.

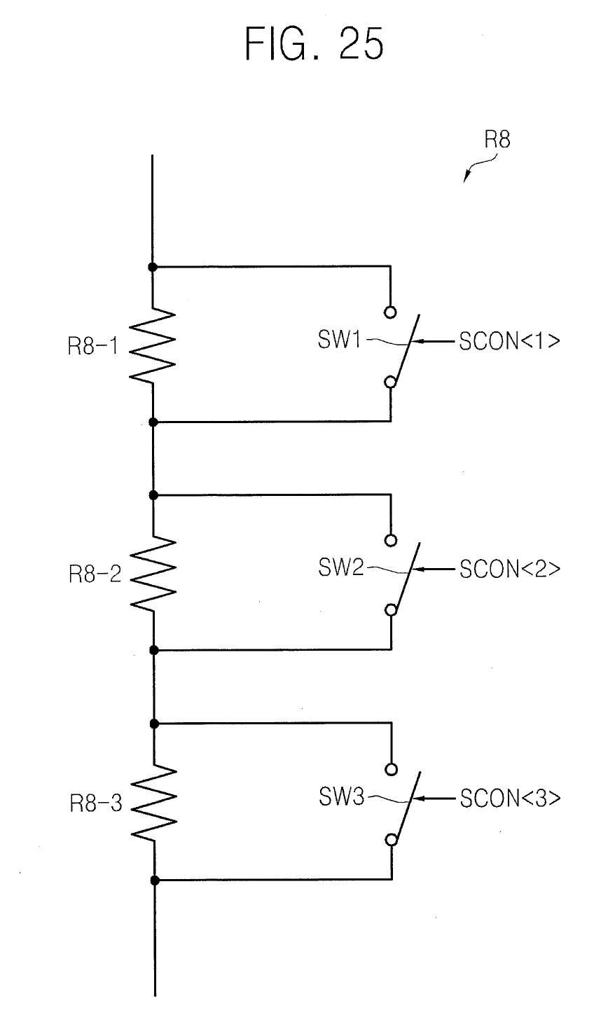

FIG. 25 is a circuit diagram of the resistance element R8 illustrated in FIG. 24 according to embodiments of the present inventive concepts.

Referring to FIG. 25, the resistance element R8 can include unit resistors R8-1, R8-2, and R8-3 and at least one switch SW1, SW2, and SW3. In detail, the first through third unit resistors R8-1, R8-2, and R8-3 can be connected in series with one another and can be respectively connected in parallel with the first through third switches SW1 through SW3. The connection among the unit resistors R8-1, R8-2, and R8-3 and the switches SW1 through SW3 can be changed in various ways. Each of the switches SW1 through SW3 can be implemented by a transmission gate (not shown).

The effective resistance of the resistance element R8 can be changed depending whether the first through third switches SW1 through SW3 are closed or opened. The first through third switches SW1 through SW3 can be closed or opened in response to a resistance control signal SCON<1:3> output from the control block 185.

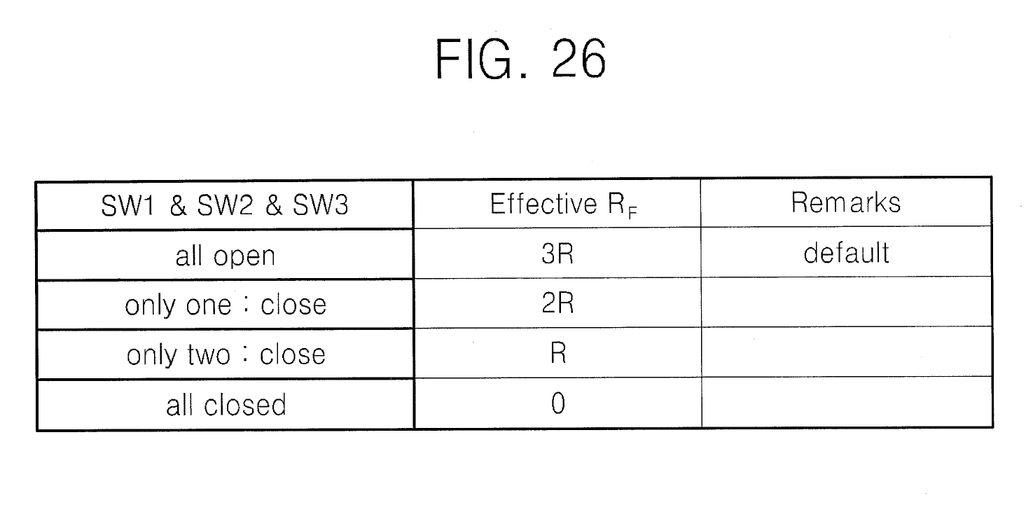

FIG. 26 is a table showing an effective resistance R_{F} according to the state of the first through third switches SW1 through SW3, i.e., the on or off states in the resistance element R8 illustrated in FIG. 25. It is assumed that the resistance of each of the first through third unit resistors R8-1, R8-2, and R8-3 is R in the current embodiments. In other embodiments, the unit resistors R8-1, R8-2, and R8-3 have different resistances.

When all of the first through third switches SW1 through SW3 are opened in the resistance element R8 illustrated in FIG. 25, the effective resistance R_{F} of the resistance element R8 is 3R. A voltage difference between the transition nodes N2 and N3 at this time is referred to as a fourth voltage gap Vgap3. In an embodiment, the default state of the resistance element R8 is when all of the first through third switches SW1 through SW3 are opened.

When only one of the first through third switches SW1 through SW3 is closed, two of the unit resistors R8-1, R8-2, and R8-3 are connected in series, so the effective resistance R_{F} of the resistance element R8 is 2R. When a voltage difference between the transition nodes N2 and N3 at this time is referred to as a fifth voltage gap Vgap4, the fifth voltage gap Vgap4 is less than the fourth voltage gap Vgap3.

When only two of the first through third switches SW1 through SW3 are closed, only one of the unit resistors R8-1, R8-2, and R8-3 is connected, so the effective resistance R_{F} of the resistance element R8 is R. When a voltage difference between the transition nodes N2 and N3 at this time is referred to as a sixth voltage gap Vgap5, the sixth voltage gap Vgap5 is less than the fifth voltage gap Vgap4.

When all of the first through third switches SW1 through SW3 are closed, the effective resistance R_{F} of the resistance element R8 is 0. A voltage difference between the transition nodes N2 and N3 at this time can be referred to as a seventh voltage gap Vgap6. Accordingly, the seventh voltage gap Vgap6 is less than the sixth voltage gap Vgap5.

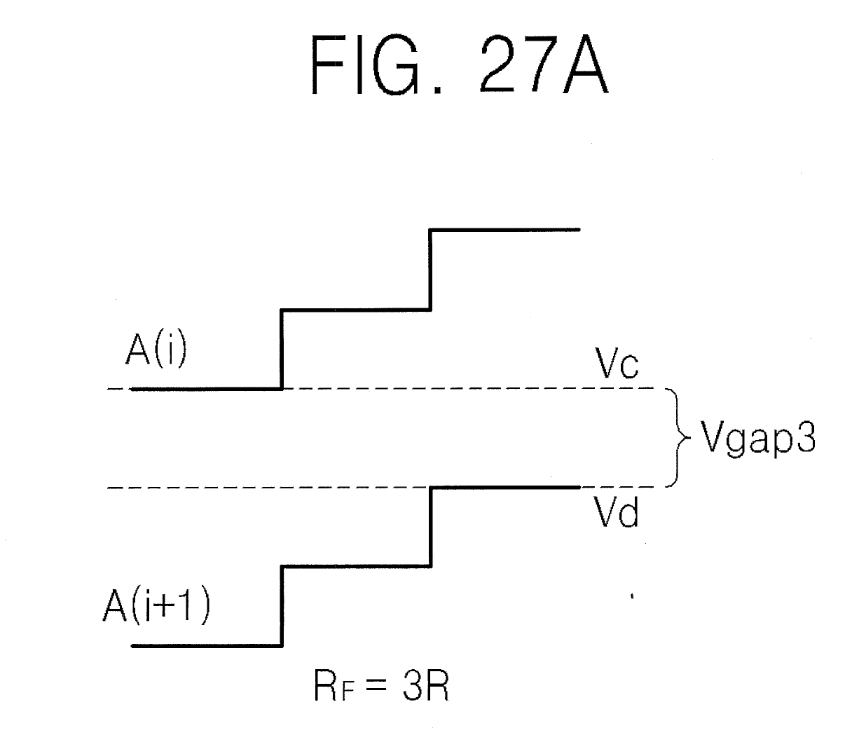

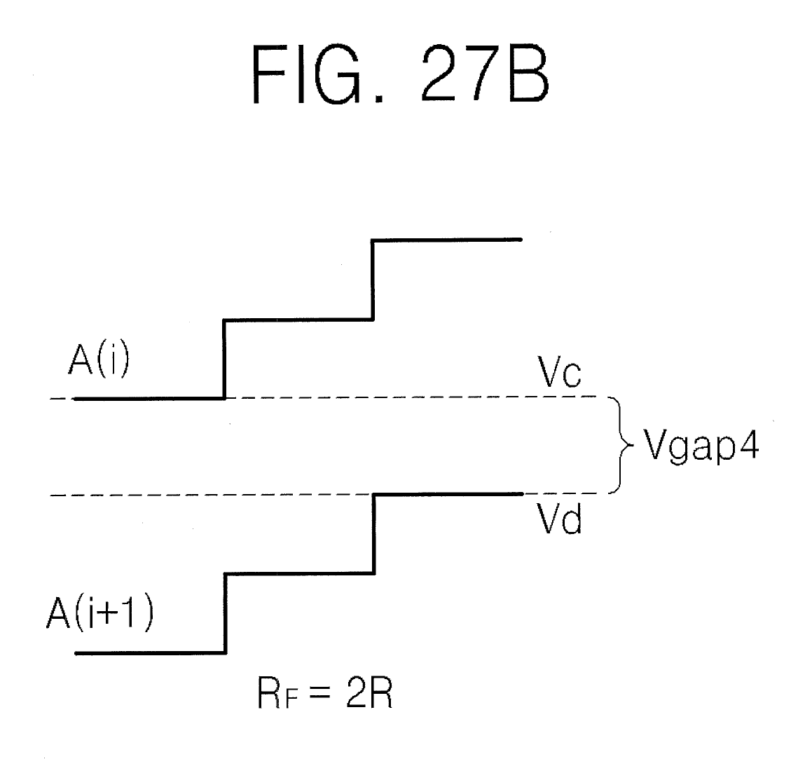

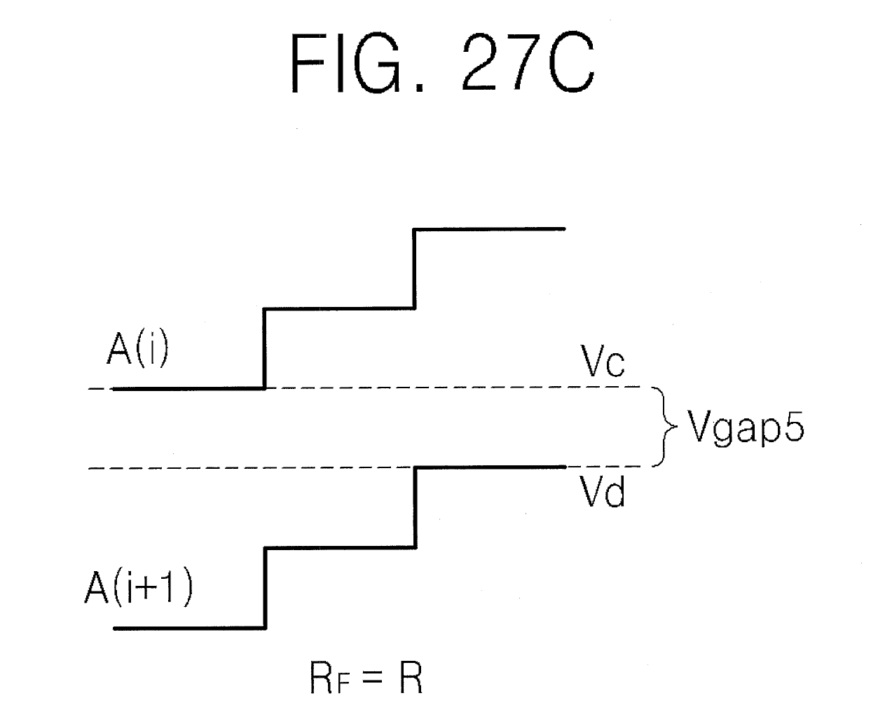

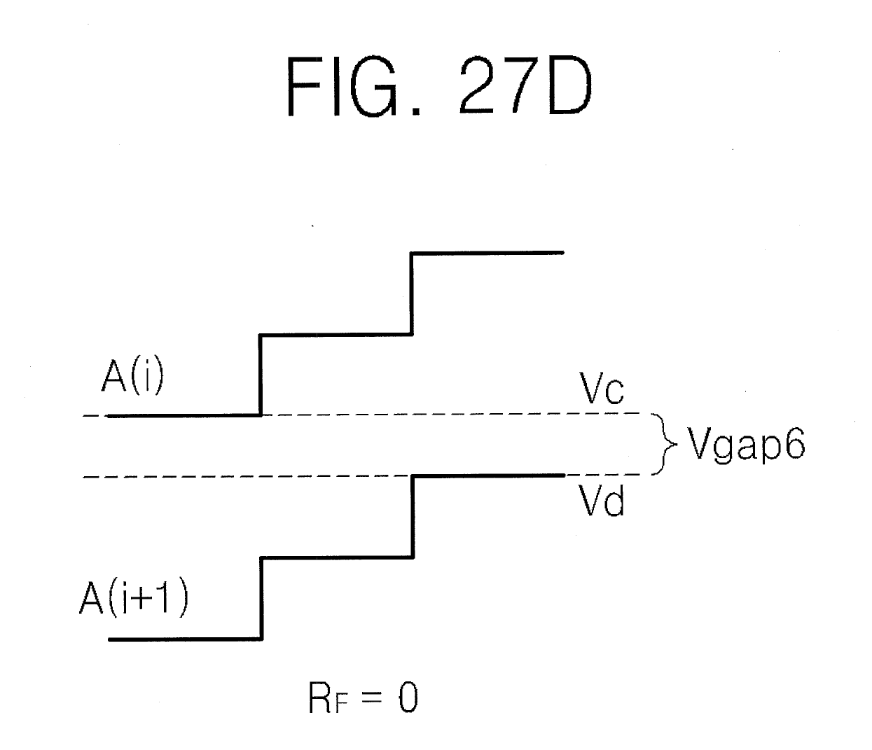

FIGS. 27A through 27D are diagrams of the global gamma voltage signals A(i) and A(i+1) having the fourth through seventh voltage gaps Vgap3 through Vgap6, respectively, according to the on/off states of the first through third switches SW1 through SW3 illustrated in FIG. 25.

Referring to FIGS. 27A through 27D, the fourth through seventh voltage gaps Vgap3 through Vgap6 can be different between the lowest grayscale voltage in the i-th (e.g., second) global gamma voltage signal A(i) and the highest grayscale voltage in the (i+1)-th (e.g., third) global gamma voltage signal A(i+1).

As described above, when the resistance element R8 is configured to include a switch so that the effective resistance R_{F} of the resistance element R8 is changed depending on whether the switch is closed or opened, a difference between grayscale voltages can be controlled. In particular, a voltage difference between a signal input to one global amplifier, e.g., 422 and a signal input to an adjacent global amplifier, e.g. 423 is controlled, so that a voltage difference between output signals, i.e. A(i) and A(i+1) of the two global amplifiers 422 and 423 is controlled to have a desired value. Accordingly, non-monotonicity that would otherwise be caused by different offsets between the two global amplifiers 422 and 423 is reduced.

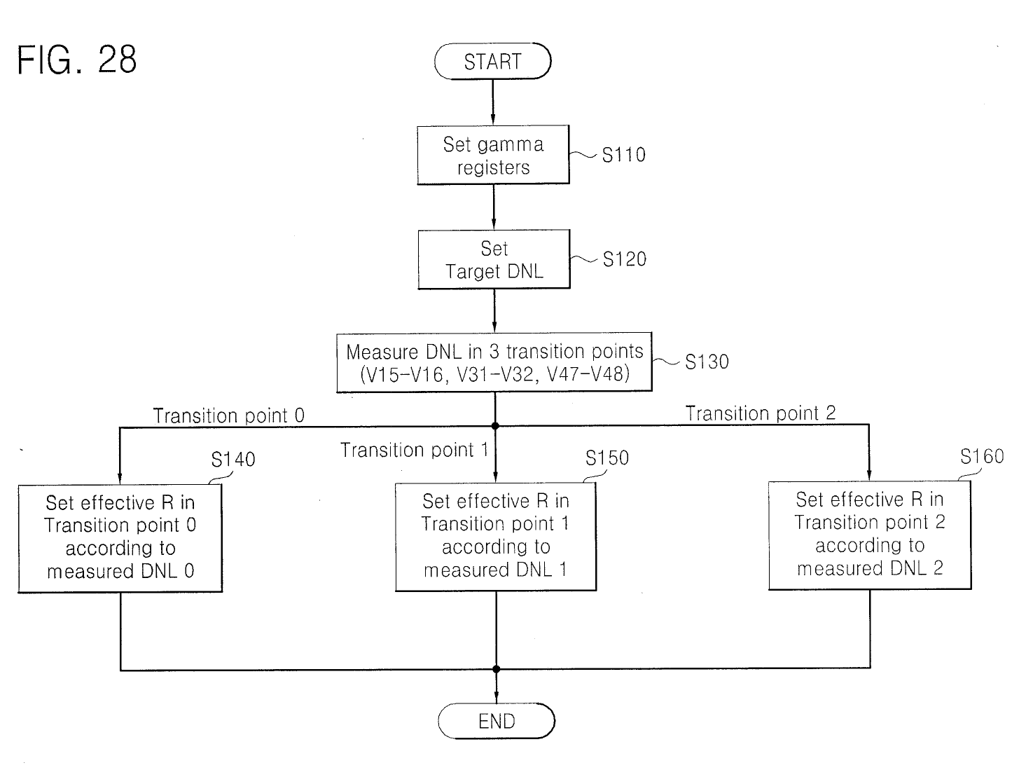

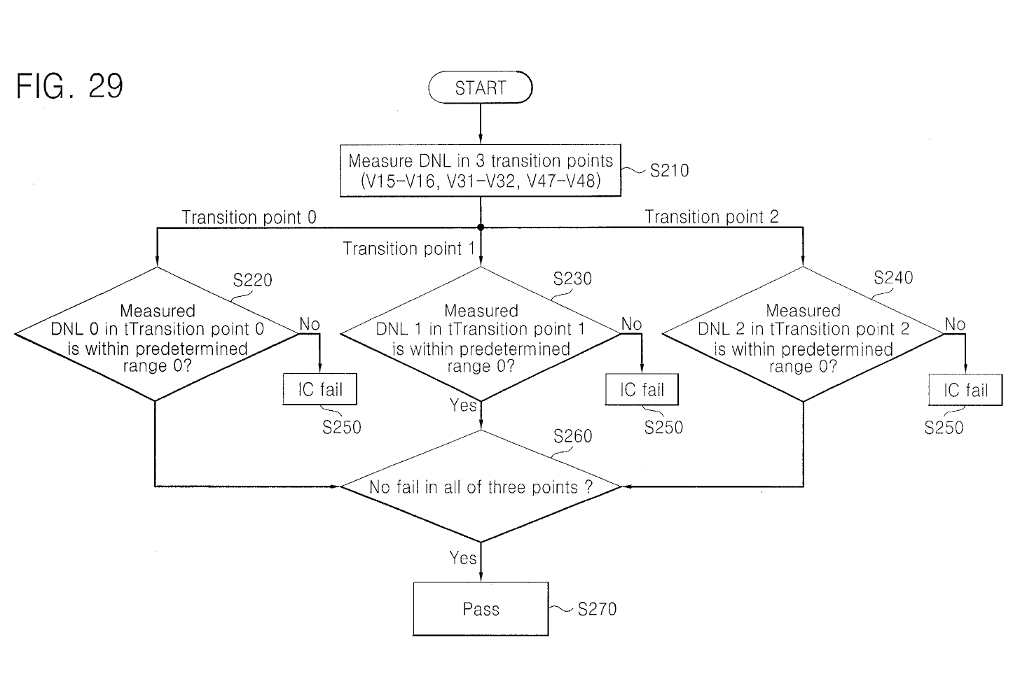

FIGS. 28 and 29 are flowcharts of a method of driving a display device according to other embodiments of the present inventive concepts. The method illustrated in FIGS. 28 and 29 can be applied to a source driver according to some embodiments of the present inventive concepts described above.

In operation S110, one or more gamma registers (not shown) are set.

In operation S120, a target voltage difference, i.e., a target differential nonlinearity (DNL), is set. The target DNL is a DNL aimed at at a transition point. The transition point is a border between grayscale voltages belonging to different global gamma voltage signals. For instance, the transition point can fall between the lowest voltage in one, e.g., A1 in FIG. 14, of two adjacent global gamma voltage signals and the highest voltage in the other global gamma voltage signal, e.g., A2 in FIG. 14.

In the embodiments illustrated in FIG. 14, the 64 grayscale voltages V0 through V63 are divided into four groups. Each of the grayscale voltages V0 through V63 belongs to one of the first through fourth global gamma voltage signals A1 through A4. A border is formed between a first group of the grayscale voltages V0 through V15 and a second group of the grayscale voltages V16 through V31,i.e., between the grayscale voltages V15 and V16 Another border is formed between the second group of the grayscale voltages V16 through V31 and the third group the grayscale voltages V32 through V47, i.e., between the grayscale voltages V31 and V32. Another border is formed between the third group the grayscale voltages V32 through V47 and the fourth group of the grayscale voltages V48 through V63,i.e., between the grayscale voltages V47 and V48, Each can correspond to transition points. A voltage difference, i.e., a DNL, at a transition point indicates a difference between two grayscale voltages (e.g., V15 and V16, V31 and V32, or V47 and V48) at the transition point and can be a voltage difference, e.g., a difference between the grayscale voltages V15 and V16, V31 and V32, or V47 and V48, between signals respectively output from two global amplifiers.

In the current embodiments, the target DNL between V15 and V16, at the first transition point is denoted by “A”, the target DNL between V31 and V32 at the second transition point is denoted by “B”, and the target DNL between V47 and V48 at the third transition point is denoted by “C”.

In operation S130, a DNL is measured at each of the first through third transition points.

The effective resistance of at least one resistance element in a resistor string is changed according to the measured DNL when necessary so that the DNL at the transition point is controlled in operations S140, S150 and S160.

In detail, in operation S140, a determination is made whether the first DNL, e.g., between V15 and V16, measured at the first transition point falls in a predetermined first range. When the first DNL falls in the first range, any of first and second fuses in a resistance element at the first transition point are not cut. A determination is made whether the first DNL falls in a predetermined second range. When the first DNL falls in the second range, only the first fuse at the first transition point is cut. A determination is made whether the first DNL falls in a predetermined third range. When the first DNL falls in the third range, all of the first and second fuses at the first transition point are cut.

At this time, the resistance element at the first transition point is one that is connected between a first transition node, i.e., a node outputting the grayscale voltage V15 and a second transition node, i.e., a node outputting the grayscale voltage V16 in the resistor string.

In operation S150, it is checked whether the second DNL (between V31 and V32) measured at the second transition point falls in the first range. When the second DNL falls in the first range, any of first and second fuses in a resistance element at the second transition point are not cut. A determination is made whether the second DNL falls in the second range. When the second DNL falls in the second range, only the first fuse at the second transition point is cut. A determination is made whether the second DNL falls in the third range. When the second DNL falls in the third range, all of the first and second fuses at the second transition point are cut.

Here, the resistance element at the second transition point is one that is connected between a first transition node, i.e., a node outputting the grayscale voltage V31 and a second transition node, i.e., a node outputting the grayscale voltage V32 in the resistor string.

In operation S160, it is checked whether the third DNL (between V47 and V48) measured at the third transition point falls in the first range. When the third DNL falls in the first range, any of first and second fuses in a resistance element at the third transition point are not cut. A determination is made whether the third DNL falls in the second range. When the third DNL falls in the second range, only the first fuse at the third transition point is cut. A determination is made whether the third DNL falls in the third range. When the third DNL falls in the third range, all of the first and second fuses at the third transition point are cut. The resistance element at the third transition point is one that is connected between a first transition node, i.e., a node outputting the grayscale voltage V47 and a second transition node, i.e., a node outputting the grayscale voltage V48 in the resistor string.

In the above-described embodiments, a voltage difference, i.e., DNL at a transition point is controlled by changing the effective resistance of at least one resistance element in a resistor string by selectively cutting fuses in the resistance element according to a DNL measured at the transition point. Alternatively, the DNL at the transition point can be controlled by changing the effective resistance of the at least one resistance element in the resistor string by selectively closing or opening switches in the resistance element.

Thereafter, referring to FIG. 29, a verification procedure is performed in operations S210 through S270.

The verification procedure includes an operation of verifying whether a DNL changed by selectively cutting fuses or selectively opening or closing switches at a transition point is within a predetermined target range.

In operation S210, DNLs, e.g., between V15 and V16, V31 and V32, and V47 and V48, at the respective first through third transition points are measured again

In operation S220, a determination is made whether the DNL (between V15 and V16) measured at the first transition point is within the target range. When the measured DNL is not within the target range, a fail occurrence is determined in operation S250.

A determination is made whether the DNL, e.g., between V31 and V32, measured at the second transition point is within the target range in operation S230. When the measured DNL is not within the target range, a fail occurrence is determined in operation S250.

A determination is made whether the DNL (between V47 and V48) measured at the third transition point is within the target range in operation S240. When the measured DNL is not within the target range, a fail occurrence is determined in operation S250. When all DNLs, e.g., between V15 and V16, V31 and V32, and V47 and V48, measured at the first through third transition points, respectively, are within the target range in operation S260, a pass occurrence is determined in operation S270.

As described above, according to some embodiments of the present inventive concepts, fuses or switches in a resistance element in a resistor string of a grayscale voltage generator are selectively turned on or off to change the effective resistance of the resistance element, so that a voltage difference between two global gamma voltage signals respectively input to different global amplifiers (i.e., gamma amplifiers), i.e., a voltage difference at a transition point is controlled. Accordingly, when the voltage difference between the global gamma voltage signals does not fall in a target range due to the different offsets between the global amplifiers, voltages input to the global amplifiers are controlled. As a result, an offset between the global amplifiers is reduced and ultimately non-monotonicity among gamma voltages is reduced.

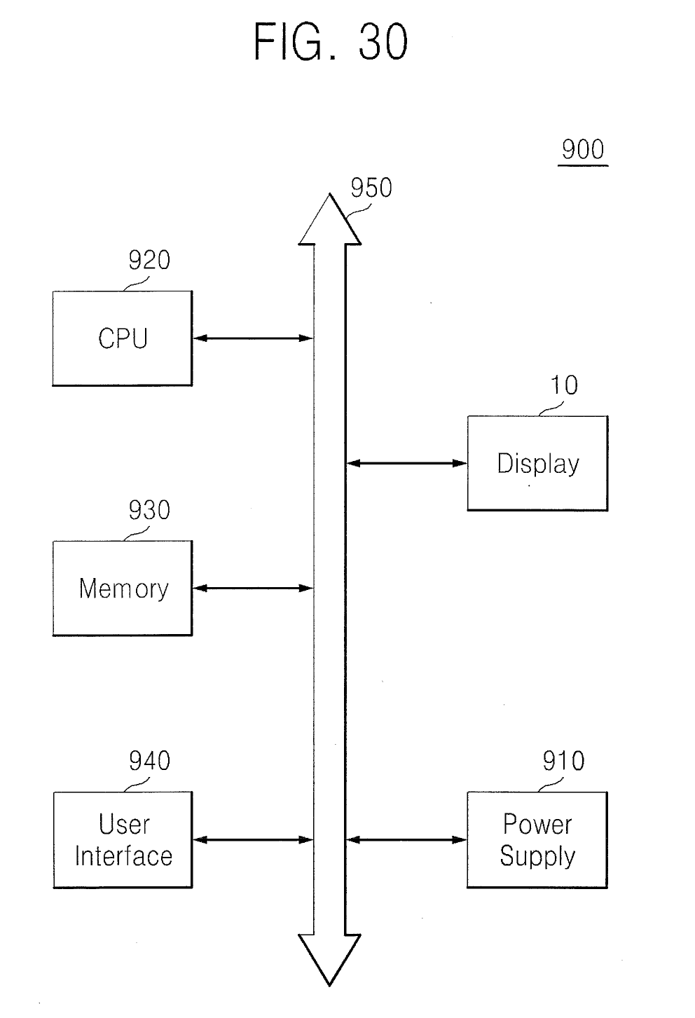

FIG. 30 is a block diagram of an electronic system 900 including the display device 10 according to some embodiments of the present inventive concepts. The electronic system 900 can be a mobile phone, a smart phone, a personal digital assistant (PDA), a camcorder, a car navigation system (CNS), or a portable multimedia player (PMP), but it is not restricted thereto.

Referring to FIG. 30, the electronic system 900 can include the display device 10, a power supply 910, a central processing unit (CPU) 920, a memory 930, a user interface 940, and a system bus 950 electrically connecting the elements 10, 910, 920, 930, and 940 with one another.

The CPU 920 controls the overall operation of the electronic system 900. The memory 930 stores information necessary for the operation of the electronic system 900. The user interface 940 provides interface between the electronic system 900 and a user. The power supply 910 supplies electric power to other elements, i.e., the CPU 920, the memory 930, the user interface 940, and the display device 10.

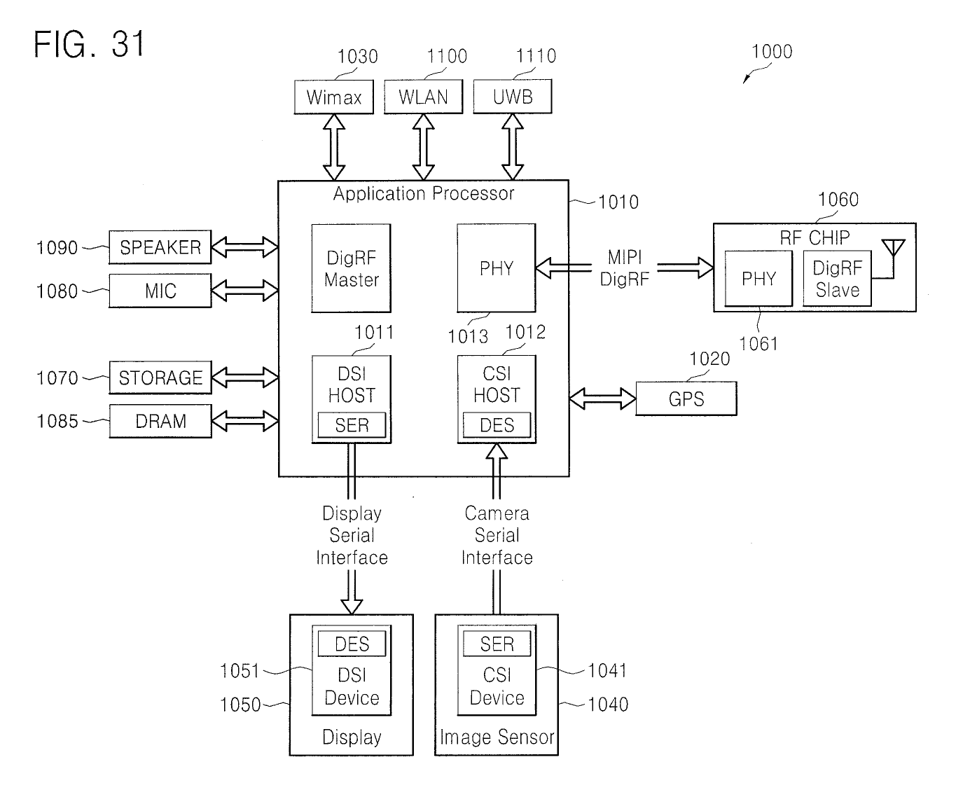

FIG. 31 is a block diagram of an electronic system 1000 including the display device 10 according to other embodiments of the present inventive concepts. Referring to FIG. 31, the electronic system 1000 can be implemented as a data processing device, such as a mobile phone, a PDA, a PMP, or a smart phone, which can use or support mobile industry processor interface (MIPI).

The electronic system 1000 includes an application processor 1010, an image sensor 1040, and a display 1050. The display 1050 can be the display device 10 described in the above-described embodiments of the present inventive concepts.

A camera serial interface (CSI) host 1012 implemented in the application processor 1010 can perform serial communication with a CSI device 1041 included in the image sensor 1040 through CSI. At this time, an optical deserializer and an optical serializer can be implemented in the CSI host 1012 and the CSI device 1041, respectively. A display serial interface (DSI) host 1011 implemented in the application processor 1010 can perform serial communication with a DSI device 1051 included in the display 1050 through DSI. At this time, an optical serializer and an optical deserializer can be implemented in the DSI host 1011 and the DSI device 1051, respectively.

The electronic system 1000 can also include a radio frequency (RF) chip 1060 communicating with the application processor 1010. A physical layer (PHY) 1013 of the application processor 1010 and a PHY 1061 of the RF chip 1060 can communicate data with each other according to MIPI DigRF and the like.

The electronic system 1000 can further include a global positioning system (GPS) 1020, a storage 1070, a microphone (MIC) 1080, a dynamic random access memory (DRAM) 1085, and a speaker 1090. The electronic system 1000 can communicate using a device complying with worldwide interoperability for microwave access (Wimax) device 1030, a wireless local area network (WLAN) device 1100, and an ultra-wideband (UWB) device 1110.

According to some embodiments of the present inventive concepts, a global amplifier causing non-monotonicity is eliminated from a source driver and pre-emphasis voltage is used to supplement the performance of driving a gamma voltage, so that the non-monotonicity caused by the global amplifier is removed. In addition, since the global amplifier occupying a large area and consuming a large amount of power is eliminated, the sizes and the power consumption of the source driver and a display device including the source driver are reduced.

According to other embodiments of the present inventive concepts, an input voltage of a global amplifier or a gamma amplifier is controlled to control gap between output voltages of global amplifiers, so that an offset between the global amplifiers is reduced. As a result, non-monotonicity among gamma voltages is reduced.

While the present inventive concepts has been particularly shown and described with reference to exemplary embodiments thereof, it will be understood by those of ordinary skill in the art that various changes in forms and details can be made therein without departing from the spirit and scope of the present inventive concepts as defined by the following claims.

1. A source driver comprising:
a global block configured to output “k” global gamma voltage signals, where “k” is 2 or an integer greater than 2, wherein each “k” global gamma voltage signal comprises a plurality of grayscale voltages and at least one pre-emphasis voltage that is output from the global block prior to each of the plurality of grayscale voltages; and
a channel driver configured to select a global gamma voltage signal of the “k” global gamma voltage signals, the selected global gamma voltage signal including a grayscale voltage of the plurality of grayscale voltages, wherein the channel driver outputs the grayscale voltage to a source line in response to the channel driver receiving image data.

2. The source driver of claim 1, wherein the global block comprises “k” gamma decoders, each “k” gamma decoder receiving first through m-th grayscale voltages that sequentially increase relative to each other, each “k” gamma decoder selectively and sequentially outputting the first through m-th grayscale voltages, and each “k” gamma decoder outputting pre-emphasis voltages at a higher voltage than the second through m-th grayscale voltages for a predetermined period of time before outputting the second through m-th grayscale voltages, respectively, according to a grayscale control signal, where “m” is 2 or an integer greater than 2.

3. The source driver of claim 2, wherein the pre-emphasis voltages comprise second through m-th pre-emphasis voltages respectively corresponding to the second through m-th grayscale voltages, wherein the second through (m−1)-th pre-emphasis voltages are the same as the third through m-th grayscale voltages, respectively, and wherein the m-th pre-emphasis voltage is a dummy voltage higher than the m-th grayscale voltage.

4. The source driver of claim 1, wherein the global block comprises “k” gamma decoders, each “k” gamma decoder receiving first through m-th grayscale voltages that sequentially decrease relative to each other, each “k” gamma decoder selectively and sequentially outputting the first through m-th grayscale voltages, and each “k” gamma decoder outputting pre-emphasis voltages at a lower voltage than the second through m-th grayscale voltages for a predetermined period of time before outputting the second through m-th grayscale voltages, respectively, according to a grayscale control signal, where “m” is 2 or an integer greater than 2.

5. The source driver of claim 4, wherein the pre-emphasis voltages comprise second through m-th pre-emphasis voltages respectively corresponding to the second through m-th grayscale voltages, wherein the second through (m−1)-th pre-emphasis voltages are the same as the third through m-th grayscale voltages, respectively, and wherein the m-th pre-emphasis voltage is a dummy voltage lower than the m-th grayscale voltage.

6. The source driver of claim 2, further comprising a grayscale voltage generator configured to generate (N+2)-level grayscale voltages, wherein the (N+2)-level grayscale voltages are divided into “k” groups of (m+2) levels and the “k” groups of (m+2) levels are respectively input to the gamma decoders, where N is m*k.

7. The source driver of claim 2, further comprising a code generation block configured to generate a plurality of pulse width modulation (PWM) signals according to a digital code generated in response to an oscillation signal.

8. The source driver of claim 7, wherein the code generation block comprises:
an oscillator configured to generate the oscillation signal;
a frequency divider configured to divide a frequency of the oscillation signal by a predetermined division factor to generate a divided oscillation signal;
a code generator configured to count the divided oscillation signal and generate the digital code as a count result; and
a PWM signal generator configured to generate the PWM signals in response to the digital code.

9. The source driver of claim 7, further comprising a grayscale controller configured to generate the grayscale control signal in response to the digital code.

10. The source driver of claim 7, wherein the grayscale control signal comprises (m+2) bits one-to-one corresponding to a first dummy voltage, first through m-th input grayscale voltages, and a second dummy voltage.

11. The source driver of claim 7, wherein the grayscale control signal comprises first through (m+2)-th bits one-to-one corresponding to a first dummy voltage, first through m-th input grayscale voltages, and a second dummy voltage, and wherein each of the “k” gamma decoders selects and outputs a voltage corresponding to an activated bit in the first through (m+2)-th bits.

12. The source driver of claim 1, wherein the channel driver comprises:
a data latch configured to divide the image data into upper bits and lower bits;
a switching signal generation circuit configured to generate a plurality of switching signals using a pulse width modulation (PWM) signal selected from among a plurality of PWM signals in response to the lower bits;
a decoder configured to output one of the “k” global gamma voltage signals in response to the upper bits; and
an output circuit configured to output the particular grayscale voltage comprised in the global gamma voltage signal output from the decoder in response to the switching signals.

13. A display device comprising:
a display panel comprising a plurality of data lines, a plurality of gate lines, and a plurality of pixels, each pixel connected to one of the data lines and one of the gate lines;
a gate driver configured to drive the gate lines; and
a source driver configured to drive the data lines, the source driver comprising:
a global block configured to output “k” global gamma voltage signals, each comprising “m” grayscale voltages and further comprising pre-emphasis voltages that correspond to the “m” grayscale voltages, where “k” and “m” are 2 or an integer greater than 2; and
a channel driver configured to select a global gamma voltage signal of the “k” global gamma voltage signals, the selected global gamma voltage signal including a grayscale voltage of the plurality of grayscale voltages, wherein the channel driver outputs the grayscale voltage to a source line in response to the channel driver receiving image data.

14. The display device of claim 13, wherein the global block comprises:
a grayscale voltage generator configured to generate the plurality of grayscale voltages;
a code generation block configured to generate a plurality of pulse width modulation (PWM) signals according to a digital code generated based on an oscillation signal; and
a global gamma voltage signal generator configured to receive the plurality of grayscale voltages and to generate the “k” global gamma voltage signals comprising the plurality of grayscale voltages that sequentially increase or decrease relative to each other, and further comprising the pre-emphasis voltages that are output from the global block prior to the plurality of grayscale voltages in response to the digital code.

15. The display device of claim 14, wherein the global gamma voltage signal generator comprises:
a grayscale controller configured to generate a grayscale control signal in response to the digital code; and
a gamma decoder configured to receive a group of first through m-th grayscale voltages among the plurality of grayscale voltages, a first dummy voltage lower than the first grayscale voltage, and a second dummy voltage higher than the m-th grayscale voltage, each gamma decoder further configured selectively and sequentially output the first through m-th grayscale voltages, and each gamma decoder configured to output pre-emphasis voltages at a higher voltage than the second through m-th grayscale voltages for a predetermined period of time before outputting the second through m-th grayscale voltages, respectively, according to the grayscale control signal.

16-24. (canceled)

25. A method of driving a plurality of data lines in a display device, the method comprising:
generating a plurality of grayscale voltages and at least one dummy voltage;
generating a plurality of global gamma voltage signals, each comprising a predetermined number of grayscale voltages which sequentially increase or decrease and a plurality of pre-emphasis voltages output prior to the predetermined number of grayscale voltages;
selecting a global gamma voltage signal of the plurality of global gamma voltage signals; and
outputting a grayscale voltage of the predetermined number of grayscale voltages to a data line in response to a receipt of image data.

26. The method of claim 25, wherein selecting the global gamma voltage signal and outputting the grayscale voltage comprise:
selecting one of the global gamma voltage signals according to upper bits in the image data; and
sampling the grayscale voltage in the selected global gamma voltage signal according to lower bits in the image data and outputting the particular grayscale voltage to the one of the data lines.

27-32. (canceled)

33. A source driver comprising:
a global block configured to output “k” global gamma voltage signals, each comprising a plurality of grayscale voltages, where “k” is 2 or an integer greater than 2; and
a channel driver configured to select a global gamma voltage signal of the “k” global gamma voltage signals and further configured to output a grayscale voltage comprised in the selected global gamma voltage signal to a source line according to image data, wherein the global block comprises a grayscale voltage generator configured to generate N-level grayscale voltages using a resistor string having an effective resistance of at least one resistance element connected between a first transition node and a second transition node changes, where N is 2 or an integer greater than 2.

34. The source driver of claim 33, wherein the first transition node is a node outputting a lowest grayscale voltage or a highest grayscale voltage of a global gamma voltage signal of the “k” global gamma voltage signals, and
the second transition node is a node outputting a lowest or highest one of the grayscale voltages comprised in another global gamma signal of the “k” global gamma voltage signals.

35. The source driver of claim 33, wherein the resistor string comprises a plurality of resistance elements connected in series between a first reference node receiving a first reference voltage and a second reference node receiving a second reference voltage, and wherein the plurality of resistance elements includes the at least one resistance element.

36. The source driver of claim 35, wherein the at least one resistance element comprises:
at least one unit resistor connected between a first node and a second node in the resistance string; and
a fuse connected in parallel with the at least one unit resistor.

37. The source driver of claim 36, wherein the fuse is initially in a connected state and is selectively cut.

38-39. (canceled)

40. The source driver of claim 35, wherein the at least one resistance element comprises:
at least one unit resistor connected between a first node and a second node in the resistance string; and
a switch connected in parallel or in series with the at least one unit resistor.

41. (canceled)

42. The source driver of claim 33, wherein the global block comprises:
a code generation block configured to generate a plurality of pulse width modulation (PWM) signals according to a digital code generated based on an oscillation signal;
a plurality of gamma decoders each of which receives a group of a predetermined number of grayscale voltages among the N-level grayscale voltages and generates one of the “k” global gamma voltage signals by sequentially outputting the predetermined number of grayscale voltages in the group according to the digital code; and
a plurality of gamma amplifiers configured to amplify and output the “k” global gamma voltage signals, respectively.

43. The source driver of claim 42, further comprising a control block configured to generate a resistance control signal to control the effective resistance of the at least one resistance element.

44. The source driver of claim 43, wherein the control block comprises:
a measurer configured to measure a voltage difference between output signals of two adjacent gamma amplifiers among the plurality of gamma amplifiers; and
a resistance control signal generator configured to generate the resistance control signal according to the voltage difference measured by the measurer.

45. The source driver of claim 43, wherein the control block comprises a memory configured to store the resistance control signal.

46. The source driver of claim 42, wherein the at least one resistance element is connected between a first node configured to output a lowest grayscale voltage of a global gamma voltage signal of the “k” global gamma voltage signals and a second node configured to output a highest grayscale voltages of another global gamma voltage signal of the “k” global gamma voltage signals.

47. The source driver of claim 46, wherein a voltage difference between two adjacent grayscale voltages belonging to different global gamma voltage signals among the “k” global gamma voltage signals changes according to the effective resistance of the at least one resistance element.

48-55. (canceled)

56. A source driver, comprising:
a global block that generates a global gamma voltage signal, the global gamma voltage signal comprising a plurality of grayscale voltages and a pre-emphasis voltage, wherein the pre-emphasis voltage is output at a predetermined period of time prior to the plurality of grayscale voltages; and
a channel driver that receives image display data, receives the global gamma voltage signal from the global block, selects a grayscale voltage of the plurality of grayscale voltage in response to the image display data, and outputs the selected grayscale voltage to a source line.

57. The source driver of claim 56, wherein the global block comprises:
a grayscale voltage generator that generates the plurality of grayscale voltages; and
a global gamma voltage signal generator including a plurality of “k” gamma decoders, where “k” is 2 or an integer greater than 2, a gamma decoder of the “k” gamma decoders outputting the pre-emphasis voltage at the predetermined period of time prior to the grayscale voltages.

58. The source driver of claim 57, wherein a gamma decoder of the “k” gamma decoders outputs first through m-th grayscale voltages of the plurality of grayscale voltages that sequentially increase relative to each other, and outputs the pre-emphasis voltage corresponding to the plurality of grayscale voltages at a higher voltage than the second through m-th grayscale voltages, in response to a grayscale control signal, where “m” is 2 or an integer greater than 2.

59. The source driver of claim 57, wherein a gamma decoder of the “k” gamma decoders outputs first through m-th grayscale voltages of the plurality of grayscale voltages that sequentially decrease relative to each other, and outputs the pre-emphasis voltage corresponding to the plurality of grayscale voltages at a lower voltage than the second through m-th grayscale voltages, in response to a grayscale control signal, where “m” is 2 or an integer greater than 2.
